(19) United States
(12) Patent Application Publication
(10) Pub. No.: US 2010/0061894 A1
(43) Pub. Date: Mar. 11, 2010

(54) APPARATUS FOR MEASURING IMMUNOCHROMATO TEST PIECE

(75) Inventor: Kazunori Yamauchi, Shizuoka (JP)

Correspondence Address: DRINKER BIDDLE & REATH (DC), 1500 K STREET, N.W., SUITE 1100, WASHINGTON, DC, 20005-1209, US

(73) Assignee: Hamamatsu Photonics K.K., Shizuoka (JP)

(21) Appl. No.: 12/516,620

(22) PCT Filed: Dec. 3, 2007
(86) PCT No.: PCT/JP2007/073294

§ 371 Date: May 28, 2009

(30) Foreign Application Priority Data
Jan. 9, 2007 (JP) 2007 001687

(51) Int. Cl. G01N 21/00

(52) U.S. Cl. 422/82.05

(57) ABSTRACT

A measuring apparatus 1a includes: light emitting elements 21 and 31, illuminating measurement light on an immunochromatographic test strip 41; a photodetecting element 22, detecting reflected light from the immunochromatographic test strip 41 due to illumination of the measurement light on a first position (band-like region 41c) on the immunochromatographic test strip 41; a photodetecting element 32, detecting reflected light from the immunochromatographic test strip 41 due to illumination of the measurement light on a second position (band-like region 41d) at a downstream side of the first position; and a controller 13, acquiring, based on output signals from the photodetecting elements 22 and 32, a time from a change of absorbance at the first position (band-like region 41c) to a change of absorbance at the second position (band-like region 41d).

### TECHNICAL FIELD

The present invention relates to an immunochromatographic test strip measuring apparatus.

### BACKGROUND ART

On an immunochromatographic test strip, an antibody (or antigen) that causes an antigen-antibody reaction with an antigen (or antibody) in a sample is coated in advance in a band-like manner in a reaction region. When a dye-labeled antigen (or antibody) in the sample is developed to the reaction region of the test strip, the antigen (or antibody) in the sample causes the antigen-antibody reaction with the antibody (or antigen) coated in band-like manner and becomes trapped, and a line colored by the dye is formed in the reaction region. With such an immunochromatographic test strip, by using a measuring apparatus to optically measure a coloration degree (reaction degree) of the line formed in the reaction region, an amount of the antigen (or antibody) in the sample can be analyzed quantitatively.

Each of Patent Documents 1 to 3 discloses an apparatus that illuminates light on an immunochromatographic test strip and detects an intensity of reflected light to measure the coloration degree of the test strip. In the apparatus disclosed in Patent Document 1, the test strip is moved with respect to a measuring system (a light emitting unit and a light receiving unit) that is fixed in position and the reflected light is detected in a continuous manner to measure the coloration degree. The apparatus disclosed in Patent Document 2 has a plurality of light emitting elements and light receiving elements disposed in parallel along a direction in which the sample flows (develops) and measures the coloration degree based on the intensity of the light reflected to the respective light receiving elements. With the apparatus described in Patent Document 3, a change of reflected light intensity is sensed at an arbitrary point on the test strip and measurement is started automatically after a fixed time from the change.

Patent Document 1: Japanese Published Unexamined Patent Application No. Hei 11-83745
Patent Document 2: Japanese Published Unexamined Patent Application No. Hei 10-274624

### Patent Document 3: Japanese Published Unexamined Patent Application No. 2003-4743

### DISCLOSURE OF THE INVENTION

### Problems to be Solved by the Invention

However, there was a problem that fluctuation of reaction degree in the reaction region occurs even when the amount of the antigen (or antibody) in the sample is the same. In order to analyze the amount of the antigen (or antibody) in the sample with good precision, influence due to such fluctuation of reaction degree is preferably suppressed as much as possible.

The present inventor found that such fluctuation of reaction degree is related to fluctuation of flow speed (development speed) of the sample. That is, some factor that causes the fluctuation of reaction degree is manifested as the fluctuation of flow speed (development speed) of the sample. Thus, by measuring the flow speed of the sample and correcting the reaction degree based on the measurement result, influence due to the fluctuation of reaction degree can be suppressed and the amount of the antigen (antibody) in the sample can be analyzed with good precision. However, with the apparatuses described in Patent Documents 1 to 3, it is difficult to perform such correction because the flow speed of a sample cannot be measured.

The present invention has been made in view of the above problem and an object thereof is to provide an immunochromatographic test strip measuring apparatus that is capable of measuring a flow speed of a sample and facilitates correction of a reaction degree based on the measurement result.

### Means for Solving the Problem

To achieve the above object, a first immunochromatographic test strip measuring apparatus according to the present invention includes: one or a plurality of light illuminating units, illuminating measurement light on an immunochromatographic test strip; a first photodetecting unit, detecting light obtained from the immunochromatographic test strip by illumination of the measurement light on a first position on the immunochromatographic test strip; a second photodetecting unit, detecting light obtained from the immunochromatographic test strip by illumination of the measurement light on a second position at a downstream side of the first position on the immunochromatographic test strip; and a controller, acquiring, based on output signals from the first and second photodetecting units, an elapsed time from a change of optical characteristic at the first position to a change of optical characteristic at the second position.

Because the sample that is developed in the immunochromatographic test strip absorbs light or is developed along with a fluorescent substance, an optical characteristic with respect to the measurement light changes at a position on the immunochromatographic test strip reached by the sample. Because the first measuring apparatus includes the first photodetecting unit, detecting the light obtained from the first position, and the second photodetecting unit, detecting the light obtained from the second position at the downstream side of the first position, by using these photodetecting units to sense the changes of optical characteristic, respective timings at which the sample reaches the first and second positions can be made known. And because the controller acquires the elapsed time from the change of optical characteristic at the first position to the change of optical characteristic at the second position, a flow speed of the sample can be measured automatically. Thus, when a reaction degree of a reaction line that causes an antigen-antibody reaction is corrected by a measurer (or automatically) based on the measurement result, influence due to fluctuation of reaction degree can be suppressed and an amount of antigen (or antibody) in the sample can be analyzed with good precision.

A second immunochromatographic test strip measuring apparatus according to the present invention includes: a light illuminating unit, illuminating measurement light on an immunochromatographic test strip; a photodetecting unit, detecting light obtained from the immunochromatographic test strip by illumination of the measurement light; a test strip support, supporting the immunochromatographic test strip; a drive mechanism, moving the test strip support and the photodetecting unit in a relative manner in a sample flow direction of the immunochromatographic test strip; and a controller, controlling the drive mechanism; and the controller makes the test strip support and the photodetecting unit move in a relative manner to detect light from a first position on the immunochromatographic test strip, then makes the test strip support and the photodetecting unit move in a relative manner to detect light from a second position at a downstream side of the first position, and acquires, based on output signals from the photodetecting unit, an elapsed time from a change of optical characteristic at the first position to a change of optical characteristic at the second position.

In the second measuring apparatus, by the drive mechanism and the controller, the test strip support and the photodetecting unit are moved in a relative manner to detect the light obtained from the first position on the test strip, and thereafter the test strip support and the photodetecting unit are moved again in a relative manner to detect the light obtained from the second position. Because the changes of optical characteristic at the first and second positions can thus be sensed favorably, the respective timings at which the sample reaches the first and second positions can be made known. And because the controller acquires the elapsed time from the change of optical characteristic at the first position to the change of optical characteristic at the second position, the flow speed of the sample can be measured automatically. Thus, when the reaction degree of the reaction line that causes the antigen-antibody reaction is corrected by the measurer (or automatically) based on the measurement result, the influence due to the fluctuation of reaction degree can be suppressed and the amount of antigen (or antibody) in the sample can be analyzed with good precision.

A third immunochromatographic test strip measuring apparatus according to the present invention includes: one or a plurality of light illuminating units, illuminating measurement light on an immunochromatographic test strip; a first photodetecting unit, detecting reflected light from the immunochromatographic test strip due to illumination of the measurement light on a first position on the immunochromatographic test strip; a second photodetecting unit, detecting reflected light from the immunochromatographic test strip due to illumination of the measurement light on a second position at a downstream side of the first position on the immunochromatographic test strip; and a controller, acquiring, based on output signals from the first and second photodetecting units, an elapsed time from a change of absorbance at the first position to a change of absorbance at the second position.

Because the sample that is developed in the immunochromatographic test strip absorbs light, the absorbance decreases at a position on the immunochromatographic test strip reached by the sample. Because the first measuring apparatus includes the first photodetecting unit, detecting the reflected light at the first position, and the second photodetecting unit, detecting the reflected light at the second position at the downstream side of the first position, by using these photodetecting units to sense the changes of absorbance, the respective timings at which the sample reaches the first and second positions can be made known. And because the controller acquires the elapsed time from the change of absorbance at the first position to the change of absorbance at the second position, the flow speed of the sample can be measured automatically. Thus, when the reaction degree is corrected by the measurer (or automatically) based on the measurement result, the influence due to the fluctuation of reaction degree can be suppressed and the amount of antigen (or antibody) in the sample can be analyzed with good precision.

The third immunochromatographic test strip measuring apparatus may include first and second light illuminating units, the first photodetecting unit may detect the reflected light due to illumination by the first light illuminating unit, and the second photodetecting unit may detect the reflected light due to illumination by the second light illuminating unit. Light can thereby be illuminated with stability on the first and second positions respectively by the first and second photodetecting units, and precision of measurement of the flow speed of the sample can thereby be improved.

Also, the third immunochromatographic test strip measuring apparatus may include: a first optical head, integrally incorporating the first light illuminating unit and the first photodetecting unit; a second optical head, integrally incorporating the second light illuminating unit and the second photodetecting unit; and at least one of the first and second optical heads may have a member surrounding optical paths of the measurement light and the reflected light. By the light illuminating unit and the photodetecting unit thus being incorporated integrally in the optical head, the light illuminating unit and the photodetecting unit are positioned with good precision with respect to each other and detection precision of reflected light can be made high. Also, by the optical paths of the measurement light and the reflected light being surrounded in at least one of the first and second optical heads, incidence of noise light on the photodetecting unit of the corresponding optical head can be prevented to further improve the detection precision of reflected light.

Also, with the third immunochromatographic test strip measuring apparatus, an interval between the first optical head and the second optical head may be variable. The interval between the first optical head and the second optical head can thereby be made to correspond readily to a size of the immunochromatographic test strip, etc.

Also, the third immunochromatographic test strip measuring apparatus may include: an optical head, integrally incorporating the first and second light illuminating units and the first and second photodetecting units; and the optical head may have a member surrounding optical paths of the measurement light and the reflected light. By the respective light illuminating units and the respective photodetecting units thus being integrally incorporated in the optical head, the light illuminating units and the photodetecting units are positioned with good precision with respect to each other and the detection precision of reflected light can be made high. Also, by the optical paths of the measurement light and the reflected light being surrounded in the optical head, incidence of noise light on the first and second photodetecting units can be prevented to further improve the detection precision of reflected light.

Also, with the third immunochromatographic test strip measuring apparatus, the second light illuminating unit may be lit after the first light illuminating unit is turned off. Because the light from the second light illuminating unit is not made incident on the first photodetecting unit and the light from the first light illuminating unit is not made incident on the second photodetecting unit in this case, the detection precision of reflected light at each of the first and second positions can be improved.

Also, with the third immunochromatographic test strip measuring apparatus, the immunochromatographic test strip may have a band-like region causing an antigen-antibody reaction with a sample, and the controller may acquire absorbance at the band-like region after elapse of a predetermined time, longer than the elapsed time, from the change of absorbance at the first position. By the controller thus acquiring the absorbance at the band-like region after the elapse of the predetermined time from the change of absorbance at the first position, because the antigen-antibody reaction progresses and the line becomes expressed clearly during the predetermined time, measurement of the reaction degree can be performed more precisely at the controller.

The third immunochromatographic test strip measuring apparatus may further include: a test strip support, supporting the immunochromatographic test strip; and a drive mechanism, controlled by the controller and moving either or both of the first and second light illuminating units and the test strip support in a relative manner in a sample flow direction of the immunochromatographic test strip; and the controller may, after elapse of the predetermined time, scan the measurement light of the first or the second light illuminating unit in the sample flow direction so that an illumination position of the measurement light passes through the band-like region. By thus scanning the band-like region that is to become the reaction line and a periphery thereof by the measurement light and detecting the reflected light, the reaction degree can be measured reliably even when an error occurs in the position of the reaction line.

Also, with the third immunochromatographic test strip measuring apparatus, the controller may turn off the second light illuminating unit after the change of absorbance at the second position and thereafter relight the second light illuminating unit to perform scanning after the elapse of the predetermined time. Because a lighting time of the second light illuminating unit can thereby be shortened, power consumption can be suppressed and life of the second light illuminating unit can be extended.

A fourth immunochromatographic test strip measuring apparatus according to the present invention includes: a light illuminating unit, illuminating measurement light on an immunochromatographic test strip; a photodetecting unit, detecting reflected light from the immunochromatographic test strip due to illumination of the measurement light; a test strip support, supporting the immunochromatographic test strip; a drive mechanism, moving the test strip support and the photodetecting unit in a relative manner in a sample flow direction of the immunochromatographic test strip; and a controller, controlling the drive mechanism; and the controller makes the test strip support and the photodetecting unit move in a relative manner to detect the reflected light from a first position on the immunochromatographic test strip, then makes the test strip support and the photodetecting unit move in a relative manner to detect the reflected light from a second position at a downstream side of the first position, and acquires, based on output signals from the photodetecting unit, an elapsed time from a change of absorbance at the first position to a change of absorbance at the second position.

In the fourth measuring apparatus, by the drive mechanism and the controller, the test strip support and the photodetecting unit are moved in a relative manner to detect the reflected light from the first position on the immunochromatographic test strip, and thereafter, the test strip support and the photodetecting unit are moved again in a relative manner to detect the reflected light from the second position. Because the changes of absorbance at the first and second positions can thus be sensed favorably, the respective timings at which the sample reaches the first and second positions can be made known. And because the controller acquires the elapsed time from the change of absorbance at the first position to the change of absorbance at the second position, the flow speed of the sample can be measured automatically. Thus, when the reaction degree is corrected by the measurer (or automatically) based on the measurement result, the influence due to the fluctuation of reaction degree can be suppressed and the amount of antigen (or antibody) in the sample can be analyzed with good precision.

Also, the fourth immunochromatographic test strip measuring apparatus may include: an optical head, integrally incorporating the light illuminating unit and the photodetecting unit; and the drive mechanism may move the test strip support and the optical head in a relative manner. By the light illuminating unit and the photodetecting unit thus being integrally incorporated in the optical head, the light illuminating unit and the photodetecting unit are positioned with good precision with respect to each other and the detection precision of reflected light can be made high.

Also, with the fourth immunochromatographic test strip measuring apparatus, the immunochromatographic test strip may have a band-like region causing an antigen-antibody reaction with a sample, and the controller may acquire absorbance at the band-like region after elapse of a predetermined time, longer than the elapsed time, from the change of absorbance at the first position. By the controller thus acquiring the absorbance at the band-like region after elapse of the predetermined time from the change of absorbance at the first position, because the antigen-antibody reaction progresses and the reaction line becomes expressed clearly during the predetermined time, measurement of the reaction degree can be performed more precisely at the controller.

Also, with the fourth immunochromatographic test strip measuring apparatus, the controller may, after elapse of the predetermined time, scan the measurement light of the light illuminating unit in the sample flow direction so that an illumination position of the measurement light passes through the band-like region. By thus scanning the reflected light data of the band-like region that is to become the reaction line and a periphery thereof by the measurement light and detecting the reflected light, the reaction degree can be measured reliably even when an error occurs in the position of the reaction line.

Also, with the fourth immunochromatographic test strip measuring apparatus, the controller may turn off the light illuminating unit after the change of absorbance at the second position and thereafter relight the light illuminating unit to perform scanning after the elapse of the predetermined time. Because the lighting time of the light illuminating unit can thereby be shortened, power consumption can be suppressed and life of the light illuminating unit can be extended.

Preferably with the third and fourth immunochromatographic test strip measuring apparatuses, the immunochromatographic test strip has a first band-like region, causing a first antigen-antibody reaction, and a second band-like region, disposed at a downstream side of the first band-like region and causing a second antigen-antibody reaction, the first position is disposed inside the first band-like region, and the second position is disposed inside the second band-like region. The changes of absorbance can thereby be sensed more clearly at the first position and the second position.

A fifth immunochromatographic test strip measuring apparatus according to the present invention includes: one or a plurality of light illuminating units, illuminating measurement light on an immunochromatographic test strip; a first photodetecting unit, detecting reflected light or fluorescence from the immunochromatographic test strip due to illumination of the measurement light on a first position on the immunochromatographic test strip; a second photodetecting unit, detecting reflected light or fluorescence from the immunochromatographic test strip due to illumination of the measurement light on a second position at a downstream side of the first position on the immunochromatographic test strip; and a controller, acquiring, based on output signals from the first and second photodetecting units, an elapsed time from a change of absorbance or fluorescence intensity at the first position to a change of absorbance or fluorescence intensity at the second position.

In a case where an antibody (antigen) for binding to the antigen (or antibody) in the sample is labeled by a fluorescent substance, fluorescence is generated when a position on the immunochromatographic test strip reached by the sample is excited by the measurement light. Because the sample developed in the immunochromatographic test strip also absorbs the light, the absorbance decreases at the position reached by the sample. Because the fifth measuring apparatus includes the first photodetecting unit, detecting the reflected light or fluorescence at the first position, and the second photodetecting unit, detecting the reflected light or fluorescence at the second position at the downstream side of the first position, by using these photodetecting units to sense the changes of absorbance or the changes of fluorescence intensity, the respective timings at which the sample reaches the first and second positions can be made known. And because the controller acquires the elapsed time from the change of absorbance or fluorescence intensity at the first position to the change of absorbance or fluorescence intensity at the second position, the flow speed of the sample can be measured automatically. Thus, when the reaction degree of the reaction line is corrected by the measurer (or automatically) based on the measurement result, the influence due to fluctuation of reaction degree can be suppressed and the amount of antigen (or antibody) in the sample can be analyzed with good precision.

A sixth immunochromatographic test strip measuring apparatus according to the present invention includes: a light illuminating unit, illuminating measurement light on an immunochromatographic test strip; a photodetecting unit, detecting fluorescence from the immunochromatographic test strip due to illumination of the measurement light; a test strip support, supporting the immunochromatographic test strip; a drive mechanism, moving the test strip support and the photodetecting unit in a relative manner in a sample flow direction of the immunochromatographic test strip; and a controller, controlling the drive mechanism; and the controller makes the test strip support and the photodetecting unit move in a relative manner to detect the fluorescence from a first position on the immunochromatographic test strip, then makes the test strip support and the photodetecting unit move in a relative manner to detect the fluorescence from a second position at a downstream side of the first position, and acquires, based on output signals from the photodetecting unit, an elapsed time from a change of fluorescence intensity at the first position to a change of fluorescence intensity at the second position.

In the sixth measuring apparatus, by the drive mechanism and the controller, the test strip support and the photodetecting unit are moved in a relative manner to detect the fluorescence from the first position on the immunochromatographic test strip, and thereafter, the test strip support and the photodetecting unit are moved again in a relative manner to detect the fluorescence from the second position. Because the changes of fluorescence intensity at the first and second positions can thus be sensed favorably, the respective timings of arrival of the sample at the first and second positions can be made known. And because the controller acquires the elapsed time from the change of fluorescence intensity at the first position to the change of fluorescence intensity at the second position, the flow speed of the sample can be measured automatically. Thus, when the reaction degree of the reaction line is corrected by the measurer (or automatically) based on the measurement result, the influence due to the fluctuation of reaction degree can be suppressed and the amount of antigen (or antibody) in the sample can be analyzed with good precision.

### EFFECT(S) OF THE INVENTION

By the immunochromatographic test strip measuring apparatus according to the present invention, the flow speed of the sample can be measured and correction of the reaction degree based on the measurement result can be facilitated.

### BRIEF DESCRIPTION OF THE DRAWINGS

FIG. 1 is a perspective view of a first embodiment of an immunochromatographic test strip measuring apparatus according to the present invention.

FIG. 2 is a plan view of an immunochromatographic test utensil.

FIG. 3 is a side sectional view of an optical head taken along a movement direction of a sample.

FIG. 4 is a perspective view of the optical head and the immunochromatographic test utensil.

FIG. 5 is a perspective view of the optical head and the immunochromatographic test utensil.

FIG. 6 is a sectional view taken on section VI-VI of the optical head shown in FIG. 5.

FIG. 7 is a flowchart of operation of the measuring apparatus according to the first embodiment.

FIG. 8 is a flowchart of operation of the measuring apparatus according to the first embodiment.

FIG. 9 is a perspective view for describing an operating state of the measuring apparatus of the first embodiment.

FIG. 10 is a perspective view for describing an operating state of the measuring apparatus of the first embodiment.

FIG. 11 is a perspective view for describing an operating state of the measuring apparatus of the first embodiment.

FIG. 12 is a perspective view for describing an operating state of the measuring apparatus of the first embodiment.

FIG. 13 shows (a) a schematic graph showing a manner of change of absorbance at a first position, and (b) a schematic graph showing a manner of change of absorbance at a second position.

FIG. 14 is a diagram of an example of an absorption profile of measurement light.

FIG. 15 is a table of results of an example.

FIG. 16 is a diagram plotting absorbance and time (tb−ta) of the example along coordinate axes.

FIG. 17 is a perspective view of a second embodiment of an immunochromatographic test strip measuring apparatus according to the present invention.

FIG. 18 is a flowchart of operation of the measuring apparatus according to the second embodiment.

FIG. 19 is a flowchart of operation of the measuring apparatus according to the second embodiment.

FIG. 20 is a perspective view for describing an operating state of the measuring apparatus of the second embodiment.

FIG. 21 is a perspective view for describing an operating state of the measuring apparatus of the second embodiment.

FIG. 22 is a perspective view for describing an operating state of the measuring apparatus of the second embodiment.

FIG. 23 is a perspective view for describing an operating state of the measuring apparatus of the second embodiment.

FIG. 24 is a perspective view of a configuration of a modification example of the first embodiment.

FIG. 25 is a perspective view of a configuration of another modification example of the first embodiment.

FIG. 26 is a perspective view of a third embodiment of an immunochromatographic test strip measuring apparatus according to the present invention.

FIG. 27 is a flowchart of operation of the measuring apparatus according to the third embodiment.

FIG. 28 is a flowchart of operation of the measuring apparatus according to the third embodiment.

FIG. 29 is a perspective view for describing an operating state of the measuring apparatus of the third embodiment.

FIG. 30 is a perspective view for describing an operating state of the measuring apparatus of the third embodiment.

FIG. 31 is a perspective view for describing an operating state of the measuring apparatus of the third embodiment.

FIG. 32 is a perspective view for describing an operating state of the measuring apparatus of the third embodiment.

FIG. 33 shows (a) a schematic graph showing a manner of change of absorbance at the first position, and (b) a schematic graph showing a manner of change of fluorescence intensity at the second position.

FIG. 34 is a diagram of an example of a fluorescence profile.

### DESCRIPTION OF SYMBOLS

1a-1e . . . Measuring apparatus, 2, 3, 5-9 . . . Optical head, 11 . . . Setting plate, 12 . . . Drive mechanism, 13-15 . . . Controller, 21, 31, 51, 61, 71, 72, 81, 91 . . . Light emitting element, 22, 32, 52, 62, 73, 74, 82, 92 . . . Photodetecting element, 23a . . . Aperture, 24a, 33a . . . Slit, 25 . . . . Resin member, 26 . . . PC substrate, 34 . . . Lens, 41 . . . . Immunochromatographic test strip, 41c, 41d . . . Band-like region, 42 . . . Immunochromatographic test utensil, CL . . . Control line, TL . . . Test line.

### BEST MODES FOR CARRYING OUT THE INVENTION

Embodiments of an immunochromatographic test strip measuring apparatus according to the present invention shall now be described in detail with reference to the attached drawings. In the description of the drawings, elements that are the same are provided with the same symbol and redundant description is omitted.

### First Embodiment

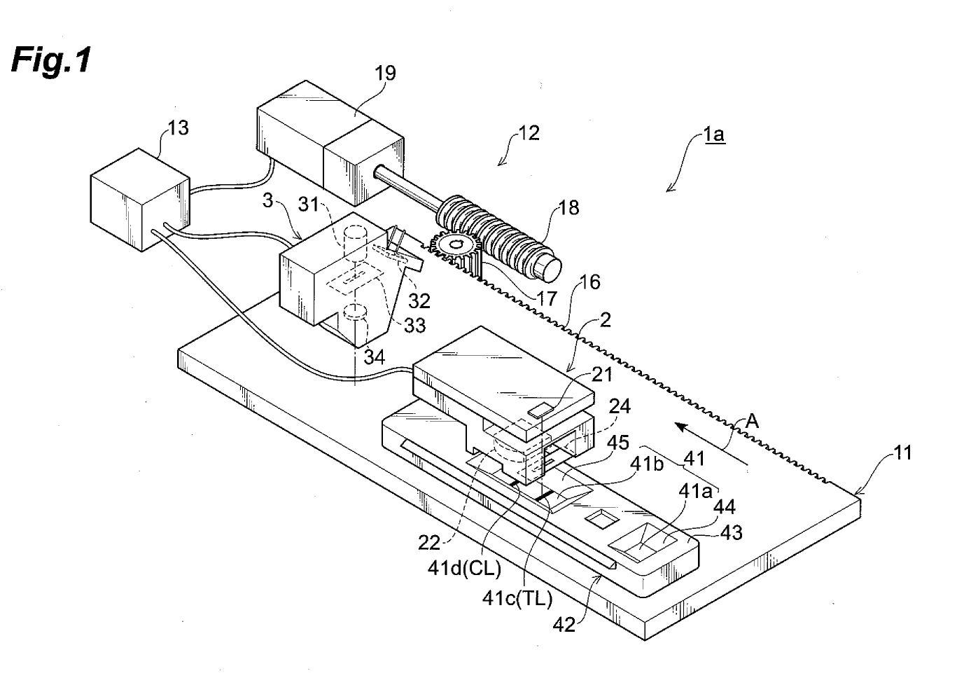

FIG. 1 is a perspective view of a first embodiment of an immunochromatographic test strip measuring apparatus according to the present invention. The measuring apparatus 1a according to the present embodiment illuminates measurement light on a test line TL and a control line CL, which are colored lines (reaction lines) formed on an immunochromatographic test strip 41, and detects intensities of reflected light to measure coloration degrees (reaction degrees) of the colored lines TL and CL. As shown in FIG. 1, the measuring apparatus 1a includes: a setting plate (test strip support) 11, for supporting an immunochromatographic test utensil 42 that has the immunochromatographic test strip 41; a first optical head 2, integrally incorporating a light emitting element (first light illuminating unit) 21, which illuminates the measurement light on the immunochromatographic test strip 41, and a photodetecting element (first photodetecting unit) 22, which detects the reflected light from the immunochromatographic test strip 41; a second optical head 3, integrally incorporating a light emitting element (second light illuminating unit) 31, which illuminates the measurement light on the immunochromatographic test strip 41, and a photodetecting element (second photodetecting unit) 32, which detects the reflected light from the immunochromatographic test strip 41; a drive mechanism 12, moving the setting plate 11 in a sample flow direction relative to the optical heads 2 and 3; and a controller 13, controlling the optical heads 2 and 3 and the drive mechanism 12.

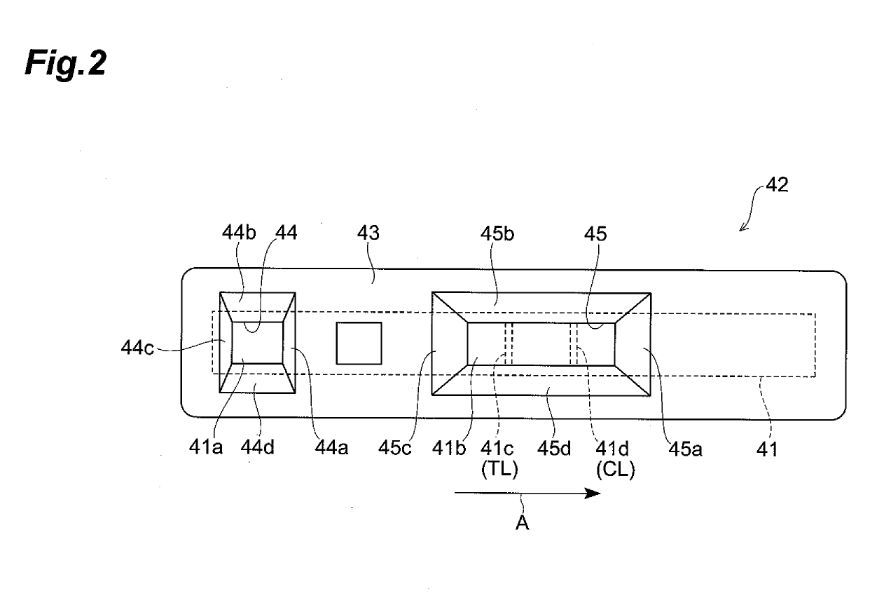

FIG. 2 is a plan view of the immunochromatographic test utensil 42. As shown in FIG. 2, the immunochromatographic test utensil 42 includes a casing 43 with a rectangular shape in plan view, and the immunochromatographic test strip 41 held inside the casing 43.

Along a direction of its long side, the casing 43 has a sample application window 44 for dropping a sample, and an observation window 45 that exposes colored portions of the immunochromatographic test strip 41. Edges 44a to 44d forming the sample application window 44 and edges 45a to 45d forming the observation window 45 have tapered shapes inclining toward the immunochromatographic test strip 41.

The immunochromatographic test strip 41 is made of a material, such as nitrocellulose membrane, filter paper, etc., and has a rectangular shape. The immunochromatographic test strip 41 includes a sample application portion 41a, disposed at a position corresponding to the sample application window 44, and a detection portion 41b, disposed at a position corresponding to the observation window 45. The detection portion 41b includes a first band-like region 41c, extending in a direction intersecting the sample flow direction (arrow A in the figure), which is a longitudinal direction of the immunochromatographic test strip 41, and a second band-like region 41d, disposed parallel and at a downstream side in the sample flow direction A with respect to the band-like region 41c. An antibody (antigen), causing a first antigen-antibody reaction with an antigen (or antibody) in the sample, is coated and fixed in a line-like (band-like) manner in the band-like region 41c, and an antibody (or antigen), causing a second antigen-antibody reaction with a dye-labeled antibody (or antigen) (hereinafter, “reference dye”) that binds with the antigen (or antibody) in the sample, is coated and fixed in a line-like (band-like) manner in the band-like region 41d.

The sample is dropped onto the sample application portion 41a of the immunochromatographic test strip 41 from the sample application window 44. An antigen (or antibody) in the sample binds with a label dye, and a complex of the antigen (or antibody) in the sample and the label dye and unreacted label dye move in the direction of the long side of the immunochromatographic test strip 41. It shall now be supposed that an antigen is contained in the sample and the antigen undergoes the antigen-antibody reaction at the band-like region 41c. In accordance with the movement of the sample, the antigen in the sample and an antibody fixed to the band-like region 41c react specifically, and a colored line (test line TL) is formed by the label dye at the reacted band-like region 41c. Meanwhile, the unreacted label dye reacts specifically with an antibody fixed to the band-like region 41d, and a colored line (control line CL) is formed by the label dye at the reacted band-like region 41d. The colored lines TL and CL normally have a width of approximately 1.0 mm. The colored lines TL and CL normally have a length in a longitudinal direction of approximately 5 mm.

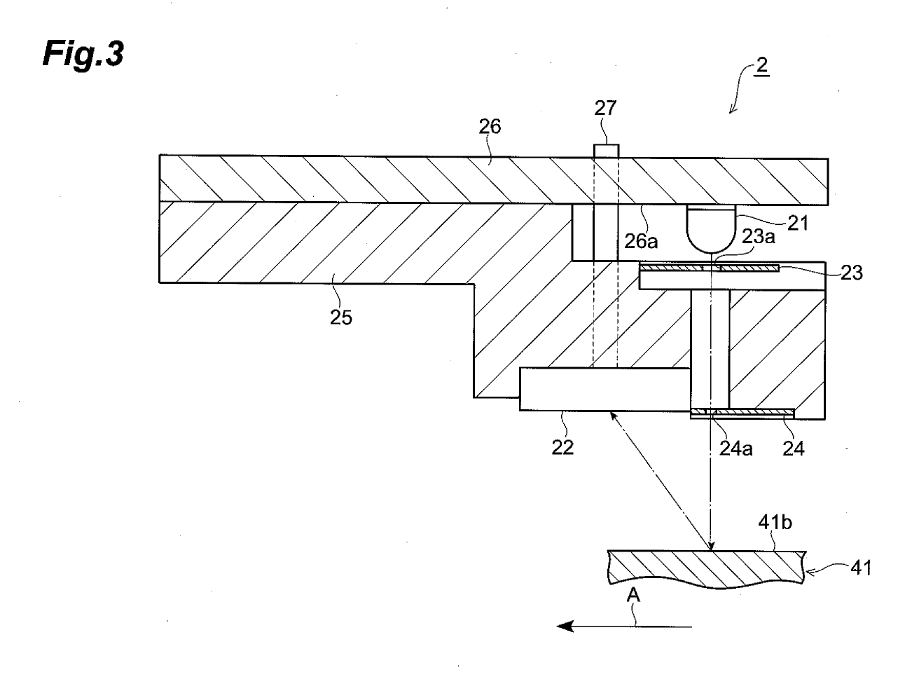

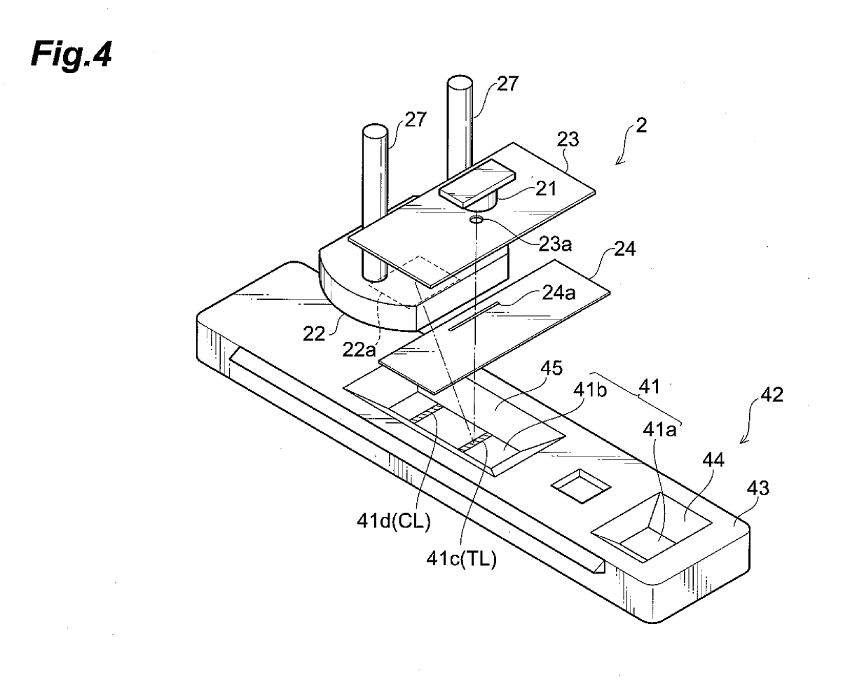

FIG. 3 is a side sectional view of the optical head 2 taken along the movement direction of the sample. FIG. 4 is a perspective view of the optical head 2 and the immunochromatographic test utensil 42. To facilitate understanding, a resin member 25 and a PC substrate 26 that the optical head 2 has are omitted from illustration in FIG. 4.

As shown in FIGS. 3 and 4, the optical head 2 includes the light emitting element 21, the photodetecting element 22, beam shaping members 23 and 24, the resin member 25 (FIG. 3), and the PC substrate 26 (FIG. 3). In the present embodiment, a semiconductor light emitting element, such as a light emitting diode (LED), is used as the light emitting element 21, and a semiconductor photodetecting element, such as a silicon (Si) photodiode, is used as the photodetecting element 22. The light emitting element 21 is mounted on a rear surface 26a of the PC substrate 26 so that an optical axis thereof is perpendicular to a top surface of the immunochromatographic test strip 41 and illuminates the measurement light on the immunochromatographic test strip 41. The photodetecting element 22 is mounted on the PC substrate 26 via two metal rods 27 joined to the photodetecting element 22, receives the reflected light from the immunochromatographic test strip 41 on a photodetection surface 22a, and converts the reflected light to an electrical signal that is in accordance with the intensity of the reflected light. The photodetecting element 22 in the present embodiment is disposed at a downstream side in the sample flow direction A with respect to the optical axis of the light emitting element 21.

The beam shaping members 23 and 24 are members for shaping the light from the light emitting element 21 to light having a beam cross section that extends in a direction substantially parallel to the band-like regions 41c and 41d of the immunochromatographic test strip 41 (see FIG. 2) and are disposed in parallel along an optical axis direction (direction perpendicular to the top surface of the immunochromatographic test strip 41) of the light emitting element 21. The beam shaping member 23 is made of a plate-like member having an aperture 23a of substantially circular shape formed therein. The beam shaping member 24 is made of a plate-like member having formed therein a slit 24a that extends substantially parallel to the band-like regions 41c and 41d. As shown in FIG. 3, the photodetecting element 22 and the beam shaping members 23 and 24 are held integrally by the block-like resin member 25 joined to the rear surface 26a of the PC substrate 26 and are thereby defined in mutual positional relationship.

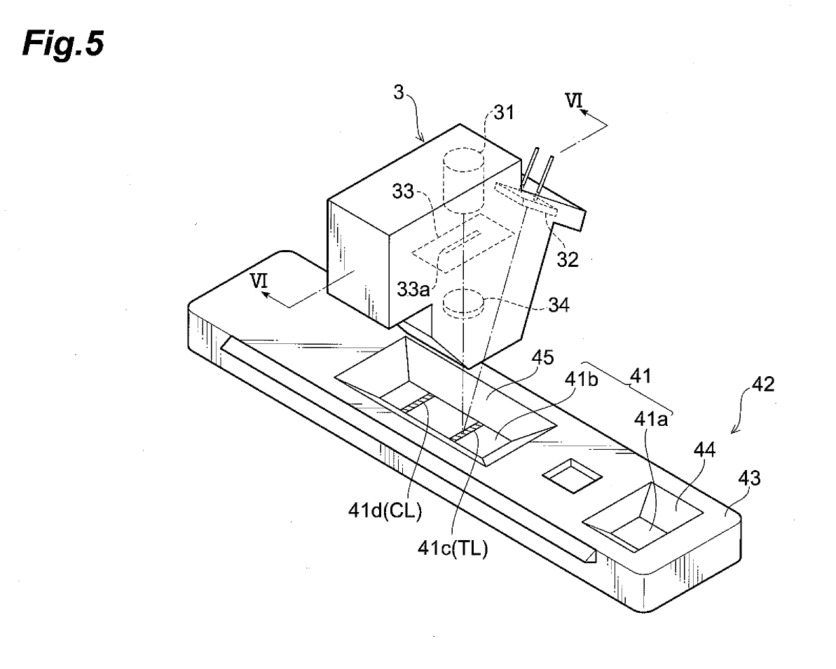

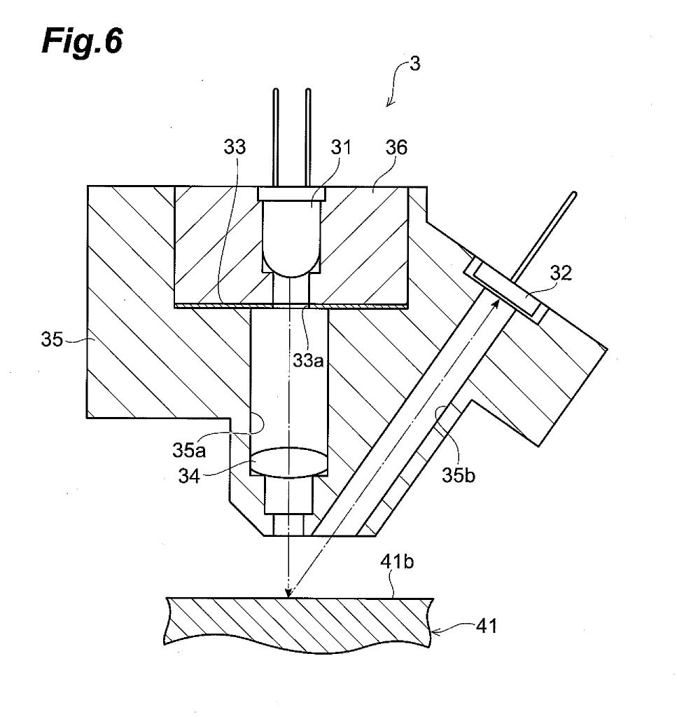

FIG. 5 is a perspective view of the optical head 3 and the immunochromatographic test utensil 42. FIG. 6 is a sectional view taken on section VI-VI of the optical head 3 shown in FIG. 5.

The optical head 3 includes the light emitting element 31, the photodetecting element 32, a beam shaping member 33, and a lens 34, and these are held integrally and defined in mutual positional relationship by members 35 and 36. In the present embodiment, a semiconductor light emitting element, such as a light emitting diode (LED), is used as the light emitting element 31, and a semiconductor photodetecting element, such as a silicon (Si) photodiode, is used as the photodetecting element 32. The light emitting element 31 is held by the member 36 so that an optical axis thereof is perpendicular to the top surface of the immunochromatographic test strip 41 and illuminates the measurement light on the immunochromatographic test strip 41. The photodetecting element 32 is disposed obliquely upward in a direction substantially parallel to the band-like regions 41c and 41d (see FIG. 2) from an illumination position of the measurement light on the immunochromatographic test strip 41 and converts reflected light from the immunochromatographic test strip 41 to an electrical signal that is in accordance with the intensity of the reflected light.

The beam shaping member 33 is a member for shaping the light from the light emitting element 31 to light having a beam cross section extending in a direction substantially parallel to the band-like regions 41c and 41d of the immunochromatographic test strip 41 (see FIG. 2). The beam shaping member 33 is made of a plate-like member having formed therein a slit 33a that extends substantially parallel to the band-like regions 41c and 41d. As shown in FIG. 6, the beam shaping member 33 is sandwiched and fixed between the member 35 and the member 36, which is fitted in a recess of the member 35 and holds the light emitting element 31. The lens 34 is for image forming of light from the beam shaping member 33 (slit light substantially parallel to the band-like regions 41c and 41d) on the immunochromatographic test strip 41. The lens 34 is disposed along an optical axis of the measurement light emitted from the light emitting element 31 and is held by the member 35.

The member 35 holds the photodetecting element 32 and the lens 34. In the member 35 are formed a hole 35a, surrounding an optical path of the measurement light emitted from the light emitting element 31, and a hole 35b, surrounding an optical path of light reflected from the immunochromatographic test strip 41 and made incident on the photodetecting element 32. At one end of the hole 35a, the light emitting element 31, held by the member 36, is disposed via the slit 33a, and the other end of the hole 35a opposes the light illumination position of the immunochromatographic test strip 41. The lens 34 is held inside the hole 35a. At one end of the hole 35b, the photodetecting element 32 is disposed, and the other end of the hole 35b opposes the light illumination position of the immunochromatographic test strip 41. In this configuration, the holes 35a and 35b function as baffles that prevent the measurement light, emitted from the light emitting element 31, from leaking to an exterior of the optical head 3 and noise light (stray light) besides the reflected light from becoming incident on the photodetecting element 32.

FIG. 1 is referred to again. The drive mechanism 12 is for moving the setting plate 11 along the sample flow direction A with respect to the optical heads 2 and 3. The drive mechanism 12 includes a pinion 17, engaging with a rack 16 formed on a side surface of the setting plate 11 along the sample flow direction A, a drive motor 19, to which is fixed a worm gear 18 that engages with the pinion 17, etc. With the drive mechanism 12, when the worm gear 18 is rotated in a forward rotation direction by the drive motor 19, the pinion 17 is driven to rotate in a speed-reduced manner, and the setting plate 11, with which the rack 16 engages with the pinion 17, moves in a direction opposite the sample flow direction A. Consequently, the optical heads 2 and 3 are moved in a relative manner with respect to the setting plate 11 in the sample flow direction A.

The controller 13 is provided for rotation control of the drive motor 19, lighting control of the light emitting elements 21 and 31, and processing of output signals from the photodetecting elements 22 and 32.

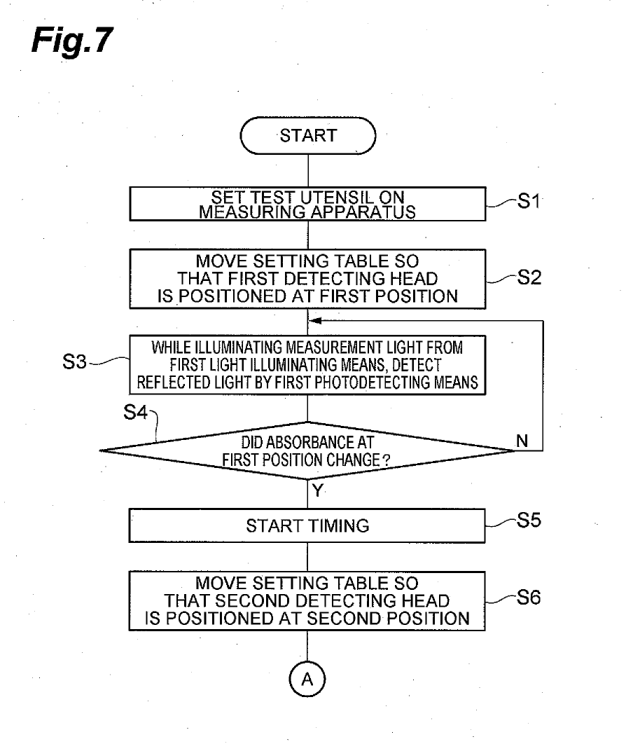

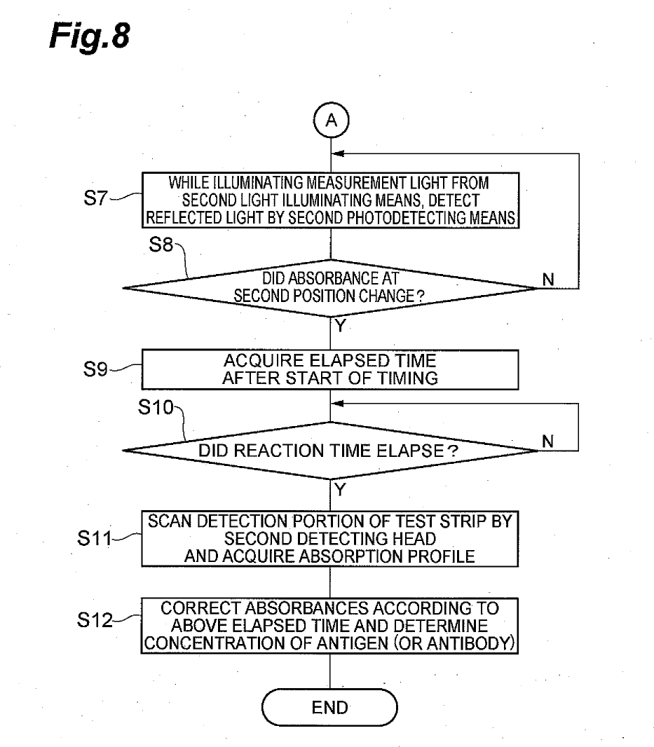

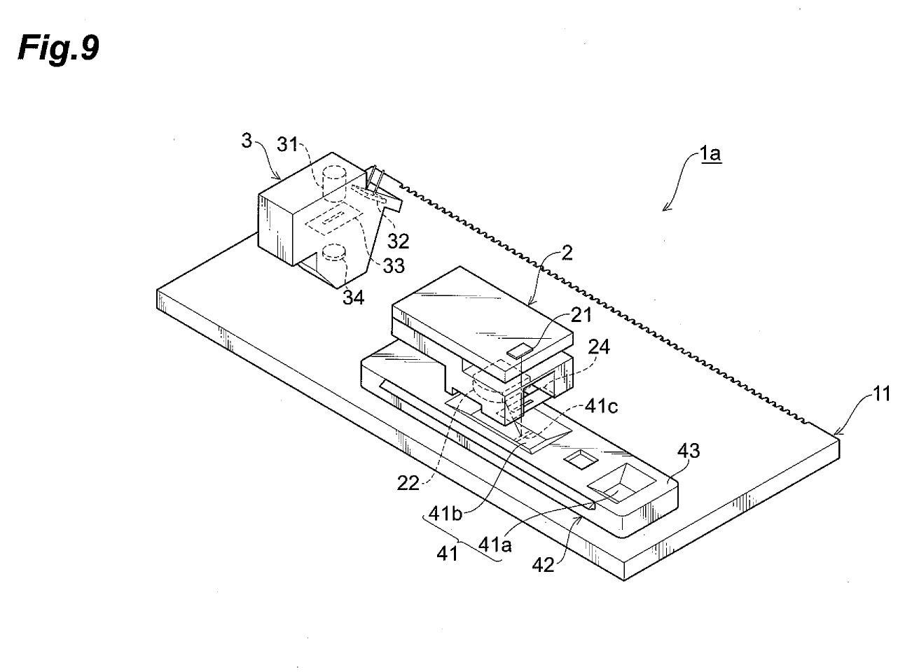

Operation of the measuring apparatus 1a according to the present embodiment shall now be described with reference to FIGS. 7 to 12. FIGS. 7 and 8 are flowcharts of the operation of the measuring apparatus 1a. FIGS. 9 to 12 are perspective views for describing operating states of the measuring apparatus 1a. In FIGS. 9 to 12, the drive mechanism 12 and the controller 13 shown in FIG. 1 are omitted from illustration.

First, a measurer sets the immunochromatographic test utensil 42 on the setting plate 11 (step S1). The controller 13 then moves the setting plate 11 and the optical head 2 in a relative manner so as to detect the reflected light from a first position on the immunochromatographic test strip 41 determined in advance. Specifically, the controller 13 moves the setting plate 11 by actuating the drive mechanism 12 and thereby controls the relative positional relationship of the optical head 2 and the immunochromatographic test strip 41 so that the first position on the immunochromatographic test strip 41 is positioned in a light emitting direction of the light emitting element 21 of the optical head 2 (specifically, a direction in which light that has passed through the aperture 23a and the slit 24a propagates) (step S2). In the present embodiment, the first position on the immunochromatographic test strip 41 is set inside the first band-like region 41c. Thus, as shown in FIG. 9, the band-like region 41c is positioned in the light emitting direction of the light emitting element 21.

Next, after the measurer drops a sample onto the sample application portion 41a, the light emitting element 21 illuminates the measurement light on the first position (that is, the band-like region 41c) of the immunochromatographic test strip 41. The photodetecting element 22 receives the reflected light and converts it to an electrical signal that is in accordance with the light intensity. The electrical signal is transmitted to the controller 13, and based on this electrical signal, the controller 13 senses the reflected light intensity at the first position (band-like region 41c) (step S3). The light emitting element 31 is unlit at this point.

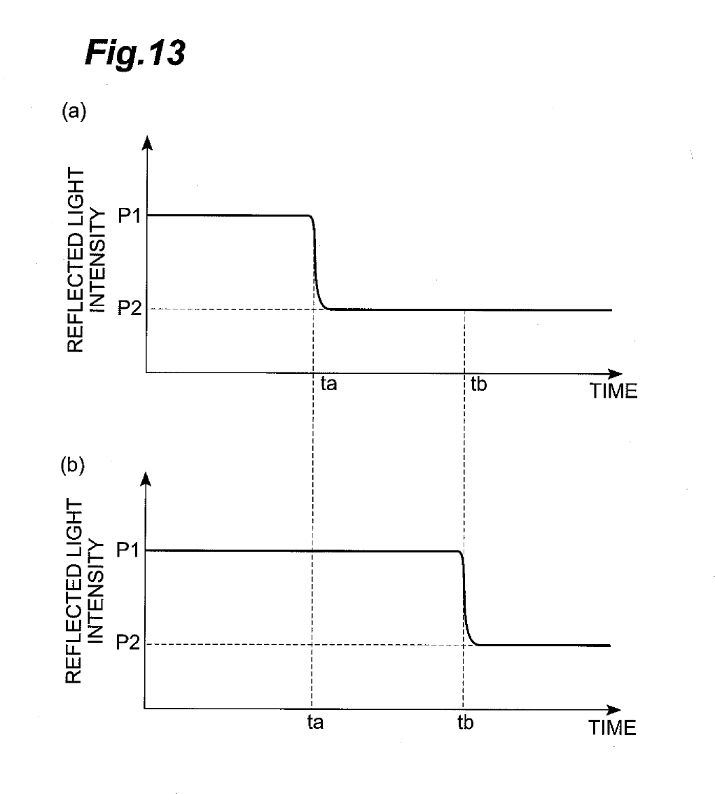

FIG. 13(a) is a schematic graph showing a manner of change of an optical characteristic (absorbance) at the first position (band-like region 41c). In FIG. 13(a), an ordinate indicates the reflected light intensity at the first position (band-like region 41c) and an abscissa indicates time. Normally, in a dry state, the immunochromatographic test strip 41 is low in absorbance and reflected light of a comparatively high intensity P1 is detected by the photodetecting element 22. When the sample reaches the first position (band-like region 41c), because the sample absorbs a portion of the measurement light and the absorbance at the first position (band-like region 41c) increases, the intensity of the light reflected to the photodetecting element 22 changes to an intensity P2 that is lower than the intensity P1. The controller 13 observes the change of absorbance based on the electrical signal from the photodetecting element 22 (step S4) and starts timing at a time to at which the absorbance changed (step S5). After sensing the change of absorbance at the first position (band-like region 41c), the controller 13 turns off the light emitting element 21.

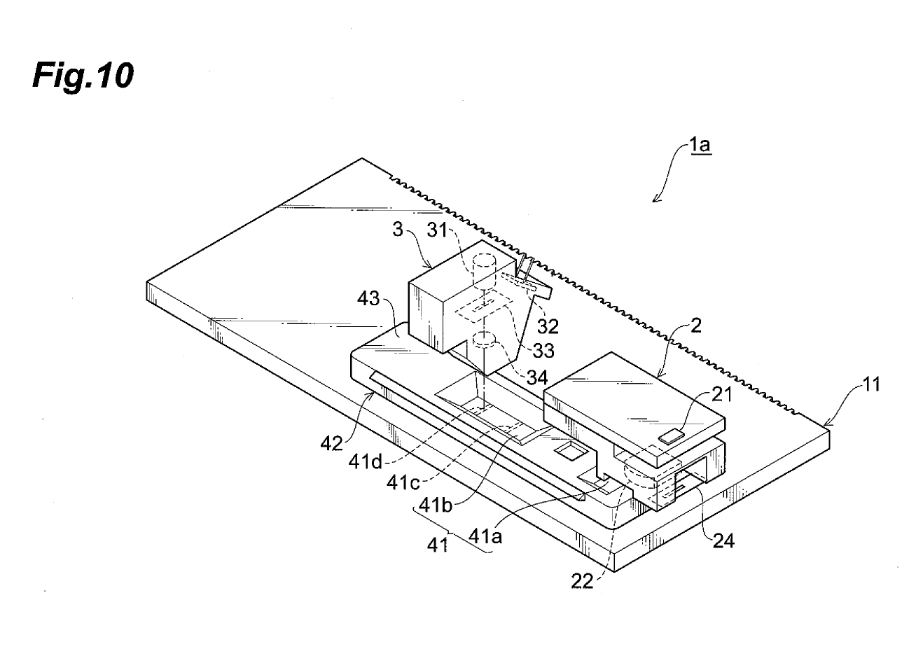

Subsequently, the controller 13 moves the setting plate 11 and the optical head 3 in a relative manner so as to detect reflected light from a second position on the immunochromatographic test strip 41 at a downstream side of the first position. Specifically, the controller 13 moves the setting plate 11 by actuating the drive mechanism 12 again and thereby controls the relative positional relationship of the optical head 3 and the immunochromatographic test strip 41 so that the second position on the immunochromatographic test strip 41 is positioned in a light emitting direction of the light emitting element 31 of the optical head 3 (specifically, a direction in which light that has passed through the slit 33a and the lens 34 propagates) (step S6). In the present embodiment, the second position on the immunochromatographic test strip 41 is set inside the second band-like region 41d. Thus, as shown in FIG. 10, the band-like region 41d is positioned in the light emitting direction of the light emitting element 31. Thereafter, the controller 13 lights the light emitting element 31, and the light emitting element 31 illuminates the measurement light on the second position (that is, the band-like region 41d) of the immunochromatographic test strip 41. The photodetecting element 32 receives the reflected light and converts it to an electrical signal that is in accordance with the light intensity. The electrical signal is transmitted to the controller 13, and based on this electrical signal, the controller 13 senses the reflected light intensity at the second position (band-like region 41d) (step S7).

FIG. 13(b) is a schematic graph showing a manner of change of an optical characteristic (absorbance) at the second position (band-like region 41d). In FIG. 13(b), the ordinate indicates the reflected light intensity at the second position (band-like region 41d) and the abscissa indicates time. As mentioned above, until the sample reaches the second position (band-like region 41d), reflected light of a comparatively high intensity P1 is detected by the photodetecting element 32. When the sample reaches the second position (band-like region 41d), because the absorbance at the second position (band-like region 41d) increases, the intensity of the light reflected to the photodetecting element 32 changes to an intensity P2 (<P1). The controller 13 observes the change of absorbance based on the electrical signal from the photodetecting element 32 (step S8) and acquires a difference between a time tb at which the absorbance changed and the time ta (tb−ta), that is, an elapsed time from the change of absorbance at the first position (band-like region 41c) to the change of absorbance at the second position (band-like region 41d) (step S9). After the absorbance at the second position (band-like region 41d) has changed, the controller 13 turns off the light emitting element 31 once.

Then, using the time ta as a reference, the controller 13 performs counting of a predetermined time (step S10). During this predetermined time, the abovementioned first and second antigen-antibody reactions proceed so that the band-like regions 41c and 41d become colored and the colored lines TL and CL become expressed. This predetermined time is set longer than the abovementioned elapsed time (tb−ta), for example, to approximately 15 minutes and adjusted as suited according to the type of the sample.

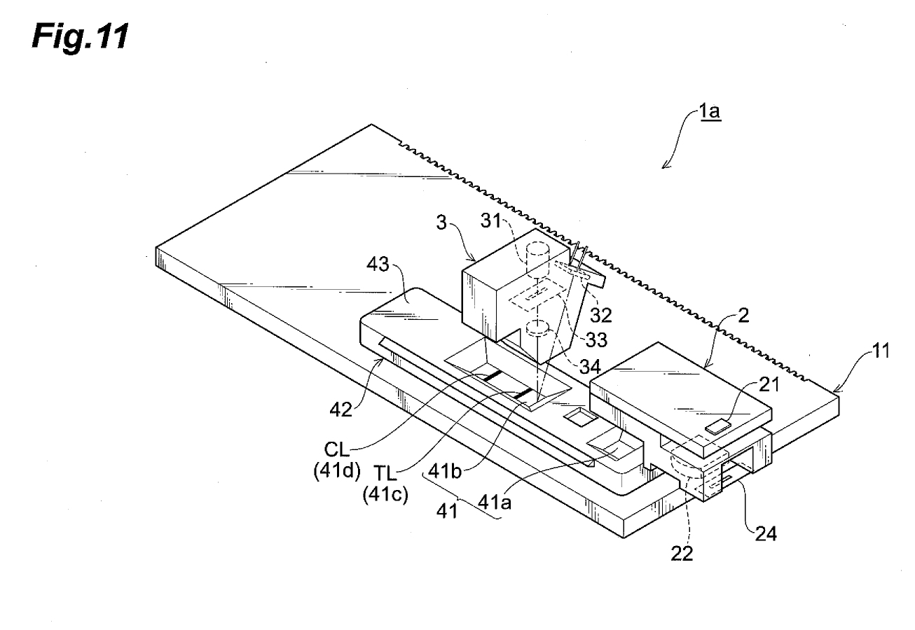

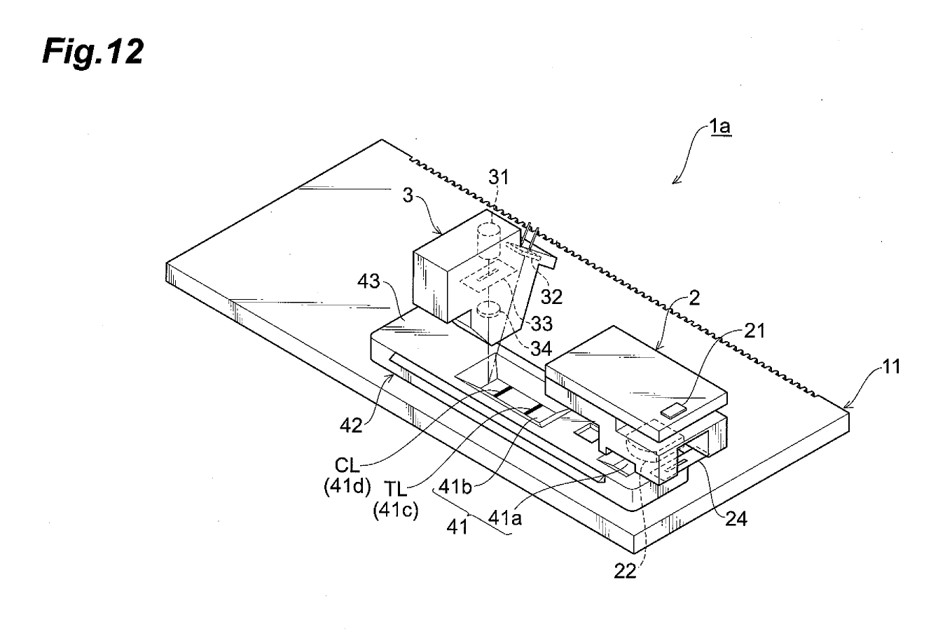

The controller 13 relights the light emitting element 31 and, after the predetermined time has elapsed from the time ta, scans the measurement light of the light emitting element 31 in the sample flow direction so that the illumination position of the measurement light passes through the band-like regions 41c and 41d, and meanwhile detects the reflected light by the photodetecting element 32 continuously (or intermittently), and obtains an absorption profile of the measurement light in the detection portion 41b (step S11). Specifically, the controller 13 actuates the drive mechanism 12 again to move the setting plate 11 and makes an end at the upstream side of the detection portion 41b be positioned in the light emitting direction of the light emitting element 31 as shown in FIG. 11. Then, while moving the illumination position of the measurement light toward the downstream side (that is, while moving the immunochromatographic test strip 41 toward the upstream side relative to the optical head 3) until an end at the downstream side of the detection portion 41b is positioned in the light emitting direction of the light emitting element 31 (see FIG. 12), the controller 13 makes the light emitting element 31 illuminate the measurement light and acquires the electrical signal that is in accordance with the reflected light intensity by the photodetecting element 32.

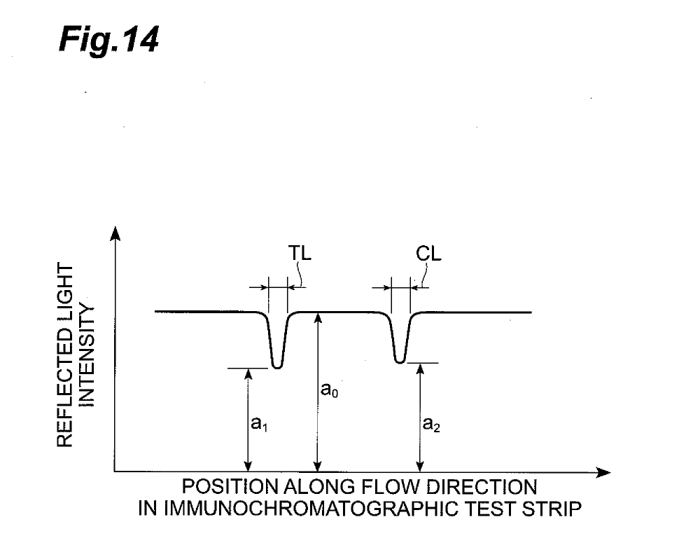

FIG. 14 is a diagram of an example of an absorption profile of measurement light obtained by the above-described operation. In FIG. 14, the ordinate indicates the reflected light intensity and the abscissa indicates the position on the detection portion 41b in the sample flow direction. The controller 13 prepares the absorption profile such as that shown in FIG. 14, and from the absorption profile, computes absorbance ABS₁ of the test line TL and absorbance ABS₂ of the control line CL on the immunochromatographic test strip 41 by the computation formulae: ABS₁ log(a₁/a₀); and ABS₂=log(a₂/a₀); respectively. The absorbances ABS₁ and ABS₂ express the respective coloration degrees of the colored lines TL and CL. Based on a relationship formula set in advance, the controller 13 corrects the absorbances ABS₁ and ABS₂ according to the time (tb−ta). The controller 13 judges success or failure of measurement based on the corrected absorbance ABS₂ of the control line CL, and references a calibration curve diagram prepared in advance to determine a total amount (concentration) of the antigen (or antibody) contained in the sample in accordance with the corrected absorbance ABS₁ of the test line TL and outputs this by a display device, printer, or other output device (step S12).

The measuring apparatus 1a according to the present embodiment thus measures the coloration degrees of the test line TL and the control line CL formed in the detection portion 41b of the immunochromatographic test strip 41.

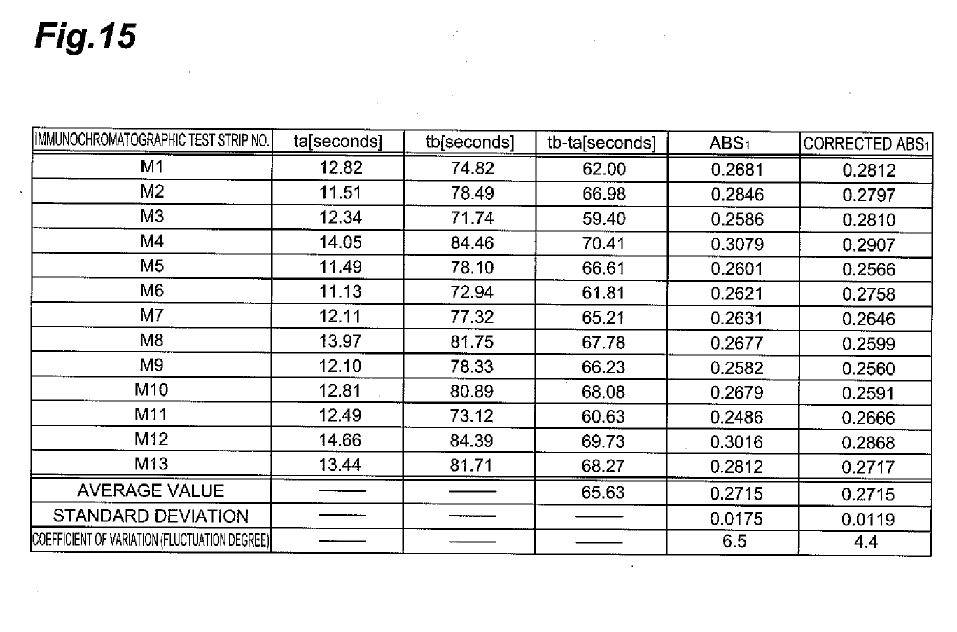

Effects obtained by the measuring apparatus 1a according to the present embodiment shall now be described. The present inventor noted that there is some form of correlation between fluctuation of coloration degree (reaction degree) at a colored line (reaction line) and fluctuation of flow speed (development speed) of the sample. As shown in FIG. 15, 13 immunochromatographic test strips M1 to M13 were actually prepared, and upon changing environmental conditions, etc., to change the flow speed among the immunochromatographic test strips M1 to M13, samples containing an antigen (or antibody) of the same concentration were dropped, and for each sample, the time ta, at which the sample passes through the first position on the immunochromatographic test strip, the time tb at which the sample passes through the second position, the difference (tb−ta), and the absorbance ABS₁ at the test line TL 15 minutes later were examined. In the example described below, nitrocellulose membranes treated with a surfactant were used as the immunochromatographic test strips, and samples, in each of which a protein was mixed at a concentration of 100 [ng/mol] in a phosphate buffer, were used.

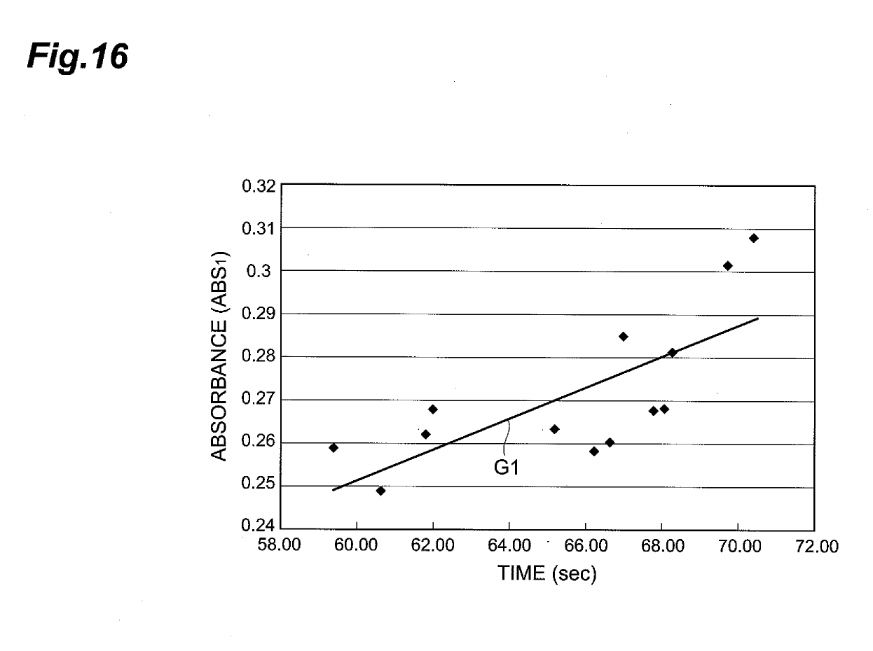

FIG. 16 is a diagram plotting the absorbance ABS₁ and the time (tb−ta) along coordinate axes. From FIG. 16, it can be understood that between the absorbance ABS₁ and the time (tb−ta), there is a correlation such that the longer the time (tb−ta), the greater the absorbance ABS₁. Thus, by expressing such a correlation by a first-order approximation line G1 as shown in FIG. 16 and correcting the absorbance ABS₁ based on the line G1, a more accurate absorbance ABS₁ that is suppressed in the influence of fluctuation of coloration degree is obtained.

In the present example, the first-order approximation line G1 is expressed by the following numerical formula (1):

ABS₁=0.0036×(tb−ta)+0.0338 (1)

Absorbances ABS₁ that were corrected using the following numerical formula (2) are shown in a rightmost column in FIG. 15:

(Corrected ABS₁)=(Measured ABS₁)−0.0036×(tb−ta) (2)

To evaluate the corrected absorbance ABS₁, coefficients of variation (fluctuation degrees) CV were computed respectively for the absorbance ABS₁ before correction and the absorbance ABS₁ after correction. As a result, the coefficient of variation CV of the absorbance ABS₁ before correction was 6.5, and the coefficient of variation CV of the absorbance ABS₁ after correction was 4.4, thus indicating that the fluctuation of the absorbance ABS₁ among the respective test strips M1 to M13 is reduced by the correction. Thus, by measuring the time (tb−ta), that is, the flow speed of the sample and correcting the absorbance (coloration degree) based on the measurement result, the influence due to the fluctuation of coloration degree can be suppressed and the amount of the antigen (or antibody) in the sample can be analyzed with good precision.

With the measuring apparatus 1a according to the present embodiment, by using the first photodetecting element 22, which detects the reflected light at the first position (band-like region 41c), and the second photodetecting element 32, which detects the reflected light at the second position (band-like region 41d), to sense the changes of absorbance at the respective positions, the timings to and tb at which the sample reaches the respective positions can be known readily. Because the controller 13 then acquires the time (tb−ta) from the change of absorbance at the first position (band-like region 41c) to the change of absorbance at the second position (band-like region 41d), the flow speed of the sample can be measured automatically. By the controller 13 (or the measurer) then correcting the absorbances (coloration degrees) of the colored lines TL and CL based on the elapsed time (tb−ta), the influence due to the fluctuation of coloration degree can be suppressed and the amount of the antigen (or antibody) in the sample can be analyzed with good precision.

Also, as in the present embodiment, it is preferable for the measuring apparatus 1a to include the light emitting elements 21 and 31, corresponding to the respective photodetecting elements 22 and 32, and for the photodetecting element 22 to detect the reflected light due to illumination by the light emitting element 21 and for the photodetecting element 32 to detect the reflected light due to illumination by the light emitting element 31. Light can thereby be illuminated with stability to each of the first position (band-like region 41c) and the second position (band-like region 41d), and detection precision of the change of absorbance and measurement precision of the flow speed of the sample can thereby be improved.

Also, as in the present embodiment, by the light emitting element 21 and the photodetecting element 22 being incorporated integrally in the optical head 2 and the light emitting element 31 and the photodetecting element 32 being incorporated integrally in the optical head 3, the light emitting element 21 and the photodetecting element 22 as well as the light emitting element 31 and the photodetecting element 32 are positioned with good precision with respect to each other and the detection precision of reflected light can be made high. Also, by at least one of the optical heads 2 and 3 (the optical head 3 in the present embodiment) having the member 35 (see FIG. 6) that surrounds the optical paths of the measurement light and the reflected light, incidence of noise light on the photodetecting element of the corresponding optical head can be prevented to further improve the detection precision of reflected light.

Also, as in the present embodiment, it is preferable with the measuring apparatus 1a that the immunochromatographic test strip 41 has the band-like regions that cause antigen-antibody reactions with the sample (the two band-like regions 41c and 41d in the present embodiment) and that the controller 13 acquires the absorbances at the band-like regions 41c and 41d after elapse of the predetermined time, longer than the time (tb−ta), from the change of absorbance at the first position (band-like region 41c). By thus acquiring the absorbances at the band-like regions 41c and 41d after the elapse of the predetermined time, longer than the time (tb−ta), from the change of absorbance at the first position (band-like region 41c), because the antigen-antibody reactions proceed during this predetermined time and the colored lines TL and CL are expressed clearly, measurement of the coloration degree can be performed more precisely at the controller 13. Also, because the change of absorbance at the first position (band-like region 41c) is set as the start of measurement of the predetermined time, unlike a case of using a measurement starting input, such as pressing of a measurement starting button by an operator, etc., problems, such as fluctuation between an input timing and a timing at which measurement should actually be started, forgetting of input, etc., do not occur.

Also, as in the present embodiment, the measuring apparatus 1a preferably includes the setting plate 11, supporting the immunochromatographic test strip 41, and the drive mechanism 12, moving the setting plate 11 and the optical heads 2 and 3 in a relative manner in the sample flow direction. Preferably, the controller 13 detects the reflected light continuously or intermittently by the photodetecting element 32 while scanning the measurement light of the light emitting element 31 in the sample flow direction so that the illumination position of the measurement light passes through the band-like regions 41c and 41d after the elapse of the predetermined time. Because the reflected light data of the band-like regions 41c and 41d that become the colored lines TL and CL and the peripheries thereof can thereby be acquired to enable preparation of an absorption profile such as shown in FIG. 14, the absorbance (coloration degree) can be measured reliably even if errors occur in the positions of the colored lines TL and CL.

Also, as in the present embodiment, preferably the controller 13 turns off the light emitting element 21 of the optical head 2 after sensing the change of absorbance at the first position (band-like region 41c) by the optical head 2 and thereafter lights the light emitting element 31 of the optical head 3 to sense the change of absorbance at the second position (band-like region 41d). Because the light from the light emitting element 31 is thus not made incident on the photodetecting element 22 during sensing of the change of absorbance at the first position (band-like region 41c) and the light from the light emitting element 21 is not made incident on the photodetecting element 32 during sensing of the change of absorbance at the second position (band-like region 41d), detection precision of reflected light at each of the first and second positions can be improved.

Also, as in the present embodiment, preferably the controller 13 turns off the light emitting element 31 once after sensing the change of absorbance at the second position (band-like region 41d) and relights the light emitting element 31 thereafter to perform the operation of step S11 shown in FIG. 8 (the scanning of the measurement light of the light emitting element 31 in the sample flow direction to obtain the absorption profile of the measurement light in the detection portion 41b). Because a lighting time of the light emitting element 31 can thus be shortened, power consumption can be suppressed and life of the light emitting element 31 can be extended. In a case where the predetermined time from the change of absorbance at the first position (band-like region 41c) to the performing of step S11 is approximately 15 minutes, the light emitting element 31 is relit, for example, at the point of elapse of approximately 14 minutes.

Also, preferably an interval between the optical head 2 and the optical head 3 in the present embodiment is variable. The interval between the optical head 2 and the optical head 3 can thereby be made to correspond readily to a size of the immunochromatographic test strip 41, etc.

Although in the present embodiment, the drive mechanism 12 moves both of the light emitting elements 21 and 31 and the setting plate 11 in a relative manner in the sample flow direction, just one of either of the light emitting elements 21 and 31 and the setting plate 11 may be moved in a relative manner in the sample flow direction instead. In this case, it is preferable to move the light emitting element for performing step S11 shown in FIG. 8 (the light emitting element 31 in the present embodiment) and the setting plate 11 in a relative manner.

### Second Embodiment

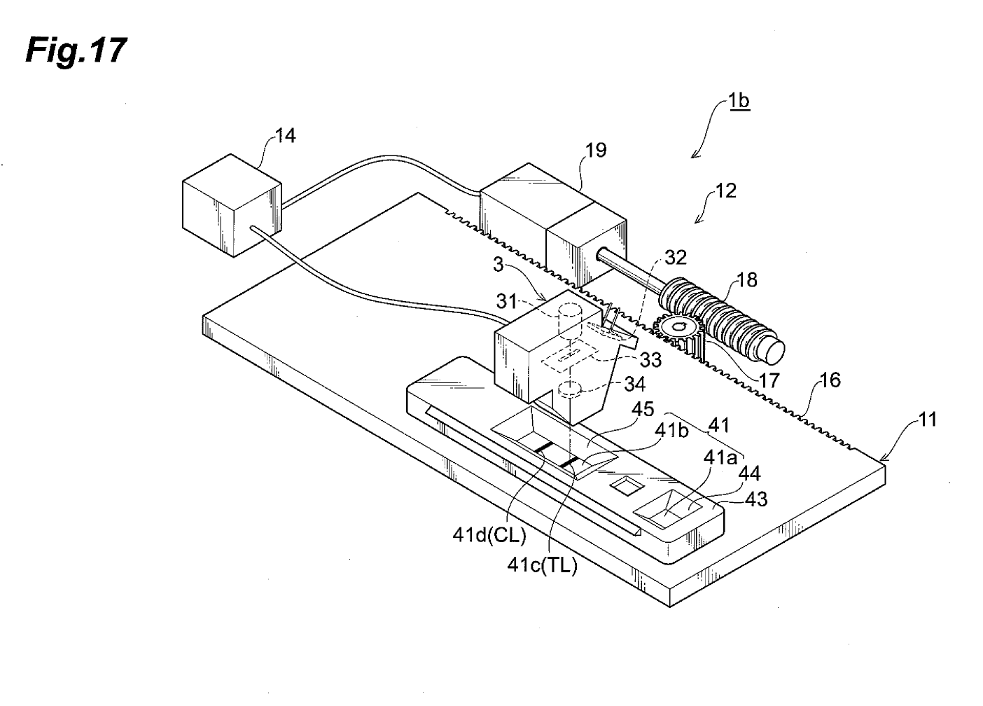

FIG. 17 is a perspective view of a second embodiment of an immunochromatographic test strip measuring apparatus according to the present invention. A difference between the measuring apparatus 1b according to the present embodiment and the first embodiment described above is the presence/non-presence of the first optical head. That is, the measuring apparatus 1b of the present embodiment does not have the optical head 2 such as shown in FIG. 1, and a controller 14 of the present embodiment performs sensing of a change of absorbance at the first position (band-like region 41c), sensing of a change of absorbance at the second position (band-like region 41d), and preparation of the absorption profile of the measurement light using the optical head 3. The configurations of the optical head 3, the drive mechanism 12, and the immunochromatographic test utensil 42 in the present embodiment are the same as those of the first embodiment.

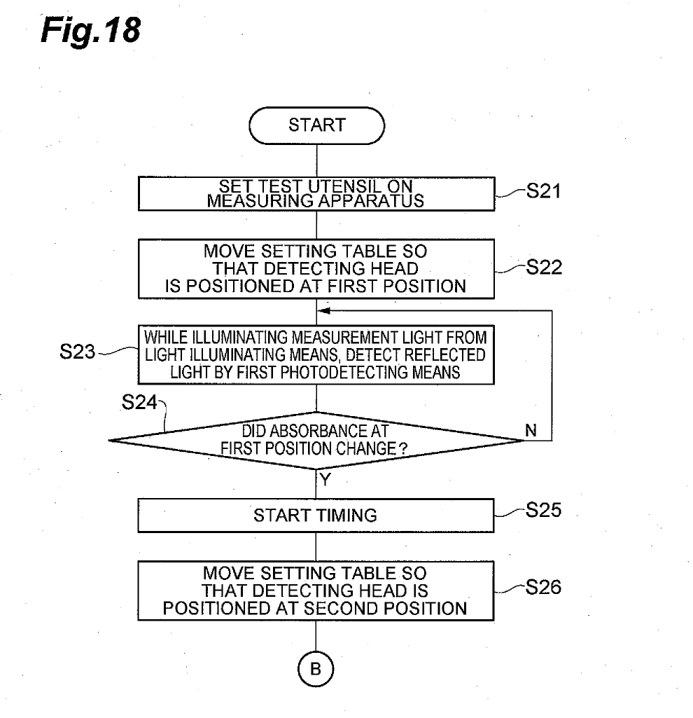

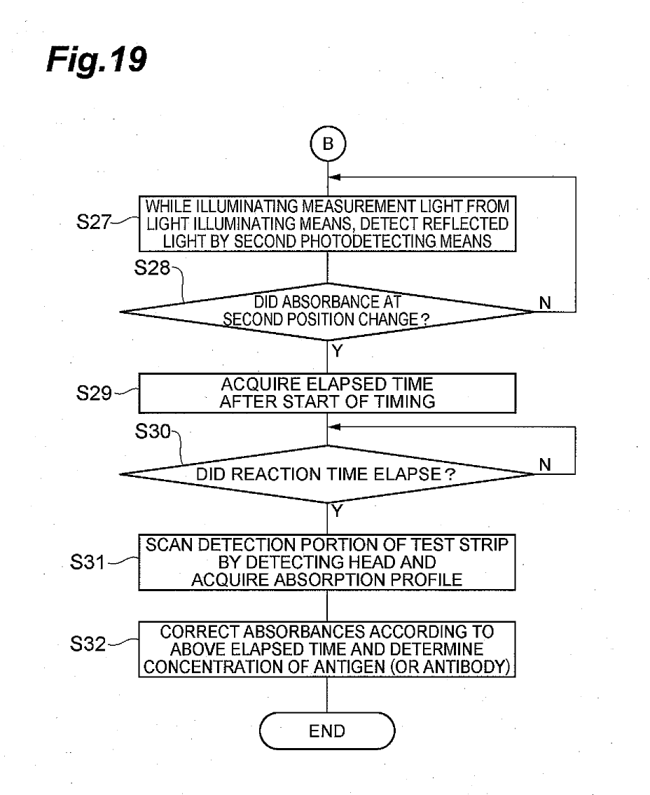

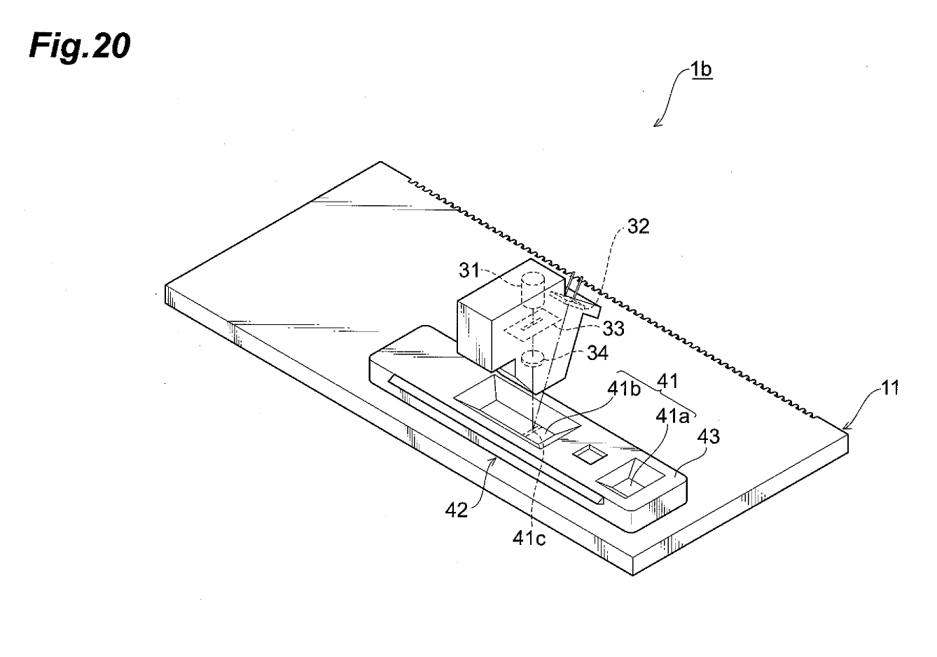

Operation of the measuring apparatus 1b according to the present embodiment shall now be described with reference to FIGS. 18 to 23. FIGS. 18 and 19 are flowcharts of the operation of the measuring apparatus 1b. FIGS. 20 to 23 are perspective views for describing operating states of the measuring apparatus 1b. In FIGS. 20 to 23, the drive mechanism 12 and the controller 14 shown in FIG. 17 are omitted from illustration.

First, a measurer sets the immunochromatographic test utensil 42 on the setting plate 11 (step S21). The controller 14 then moves the setting plate 11 and the optical head 3 in a relative manner so as to detect the reflected light from the first position (band-like region 41c) on the immunochromatographic test strip 41. Specifically, the controller 14 moves the setting plate 11 by actuating the drive mechanism 12 and thereby controls the relative positional relationship of the optical head 3 and the immunochromatographic test strip 41 so that the first position (band-like region 41c) on the immunochromatographic test strip 41 is positioned in the light emitting direction of the light emitting element 31 of the optical head 3 (see FIG. 20) (step S22).

Next, after the measurer drops a sample onto the sample application portion 41a, the light emitting element 31 illuminates the measurement light on the first position (band-like region 41c) of the immunochromatographic test strip 41. The photodetecting element 32 receives the reflected light and converts it to an electrical signal that is in accordance with the light intensity. The electrical signal is transmitted to the controller 14, and based on this electrical signal, the controller 14 senses the reflected light intensity at the first position (band-like region 41c) (step S23). The controller 14 observes the change of optical characteristic (absorbance) based on the electrical signal (step S24) and starts timing at the time to at which the absorbance changed (step S25).

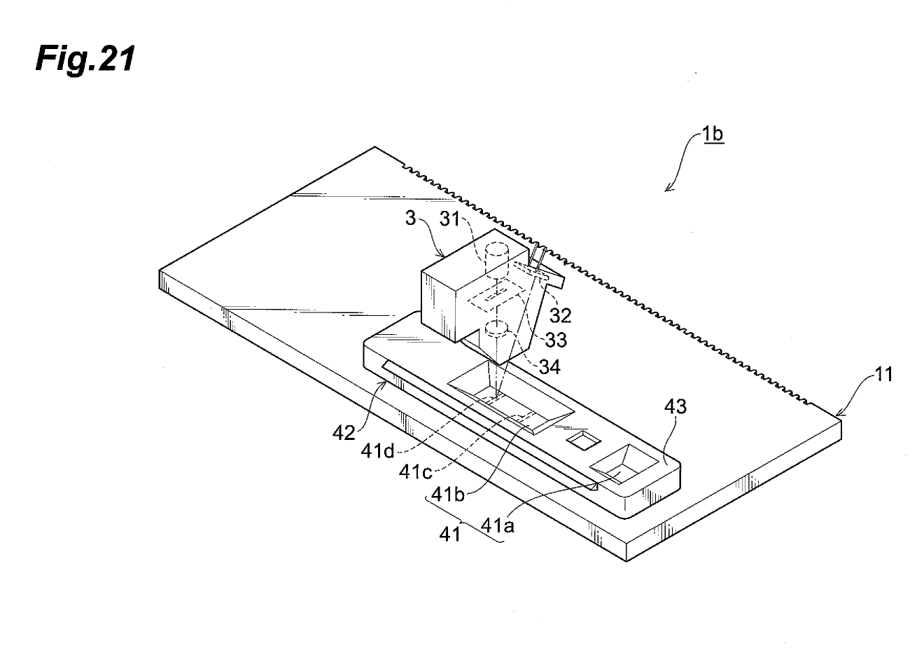

Subsequently, the controller 14 moves the setting plate 11 and the optical head 3 in a relative manner so as to detect the reflected light from the second position (band-like region 41d) on the immunochromatographic test strip 41. That is, the controller 14 moves the setting plate 11 by actuating the drive mechanism 12 again and thereby controls the relative positional relationship of the optical head 3 and the immunochromatographic test strip 41 so that the second position (band-like region 41d) on the immunochromatographic test strip 41 is positioned in the light emitting direction of the light emitting element 31 of the optical head 3 (see FIG. 21) (step S26). Thereafter, the light emitting element 31 illuminates the measurement light on the second position (band-like region 41d), and the photodetecting element 32 outputs the electrical signal that is in accordance with the reflected light intensity. Based on this electrical signal, the controller 14 senses the reflected light intensity at the second position (band-like region 41d) (step S27). The controller 14 observes the change of optical characteristic (absorbance) based on the electrical signal (step S28) and acquires the difference (tb-ta) between the time tb at which the absorbance changed and the time ta (step S29). After the absorbance has changed at the second position (band-like region 41d), the controller 14 turns off the light emitting element 31 once.

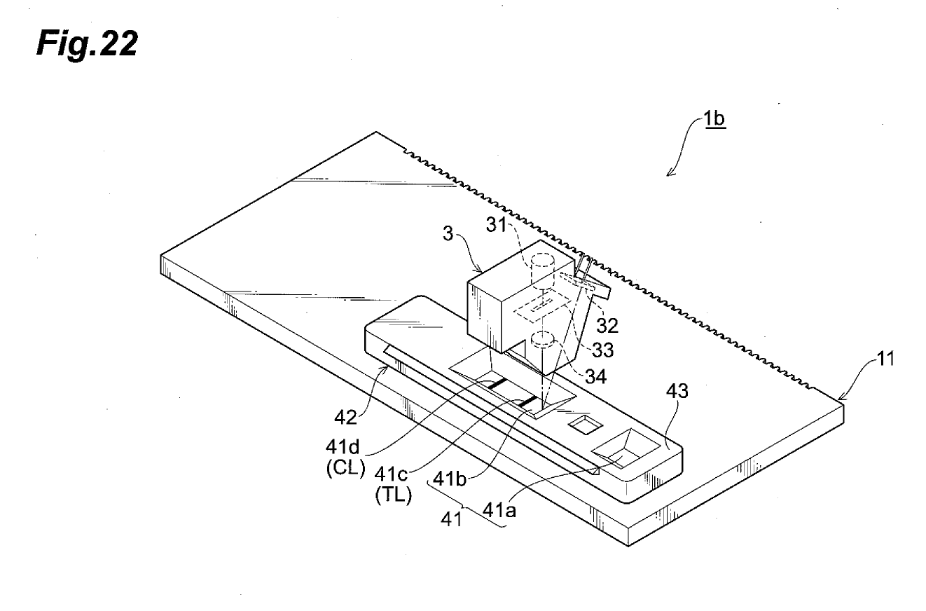

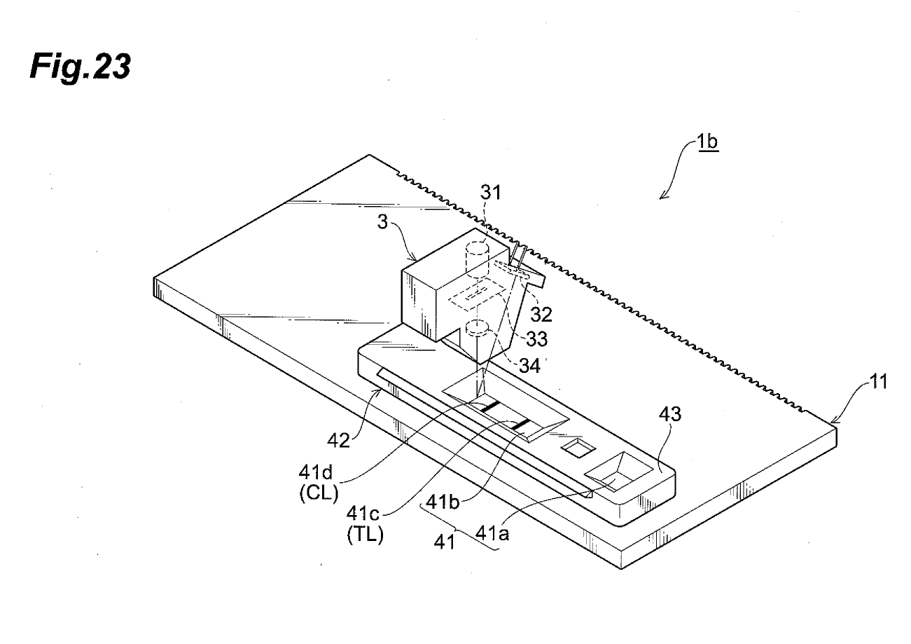

The controller 14 then performs counting of the predetermined time from the time ta (step S30). During this predetermined time, the band-like regions 41c and 41d become colored and the colored lines IL and CL become expressed. The controller 14 relights the light emitting element 31, and after the elapse of the predetermined time from the time ta, scans the measurement light of the light emitting element 31 in the sample flow direction so that the illumination position of the measurement light passes through the band-like regions 41c and 41d and meanwhile detects the reflected light by the photodetecting element 32 continuously (or intermittently) and obtains the absorption profile of the measurement light in the detection portion 41b (step S31). That is, the controller 14 actuates the drive mechanism 12 again to move the setting plate 11 and makes the end at the upstream side of the detection portion 41b be positioned in the light emitting direction of the light emitting element 31 as shown in FIG. 22. Then, while moving the illumination position of the measurement light toward the downstream side (that is, while moving the immunochromatographic test strip 41 to the upstream side relative to the optical head 3) until the end at the downstream side of the detection portion 41b is positioned in the light emitting direction of the light emitting element 31 (see FIG. 23), the controller 14 makes the light emitting element 31 illuminate the measurement light and acquires the electrical signal that is in accordance with the reflected light intensity by the photodetecting element 32.

The controller 14 then prepares the absorption profile (see FIG. 13), and from the absorption profile, computes the absorbance ABS₁ of the test line TL and the absorbance ABS₂ of the control line CL on the immunochromatographic test strip 41. Then, based on a relationship formula set in advance, the controller 14 corrects the absorbances ABS₁ and ABS₂ according to the time (tb−ta). The controller 14 judges success or failure of measurement based on the corrected absorbance ABS₂ of the control line CL, and references a calibration curve diagram prepared in advance to determine a total amount (concentration) of the antigen (or antibody) contained in the sample in accordance with the corrected absorbance ABS₁ of the test line TL and outputs this by the display device, printer, or other output device (step S32).

The measuring apparatus 1b according to the present embodiment thus measures the coloration degrees of the test line TL and the control line CL formed in the detection portion 41b of the immunochromatographic test strip 41.

With the measuring apparatus 1b according to the present embodiment, after undergoing relative movement with respect to the setting plate 11 to detect the reflected light at the first position (band-like region 41c), the first photodetecting element 22 undergoes relative movement again to detect the reflected light at the second position (band-like region 41d). The changes of absorbance at the respective positions can thereby be sensed and the timings to and tb at which the sample reaches the respective positions can be known. Because the controller 14 then acquires the time (tb−ta) from the change of absorbance at the first position (band-like region 41c) to the change of absorbance at the second position (band-like region 41d), the flow speed of the sample can be measured automatically. By the controller 14 (or the measurer) then correcting the absorbances (coloration degrees) of the colored lines TL and CL based on the time (tb−ta), the influence due to the fluctuation of coloration degree can be suppressed and the amount of the antigen (or antibody) in the sample can be analyzed with good precision.

The controller 14 acquires the absorbances at the band-like regions 41c and 41d after elapse of the predetermined time, longer than the time (tb−ta), from the change of absorbance at the first position (band-like region 41c) in the present embodiment as well. Because the antigen-antibody reactions thereby proceed adequately and the colored lines TL and CL are expressed clearly, measurement of the coloration degree can be performed more precisely at the controller 14. Also, because the change of absorbance at the first position (band-like region 41c) is set as the start of measurement of the predetermined time, unlike a case of using a measurement starting input, such as pressing of a measurement starting button by an operator, etc., problems, such as fluctuation between an input timing and a timing at which measurement should actually be started, forgetting of input, etc., do not occur.

The controller 14 detects the reflected light continuously or intermittently by the photodetecting element 32 while scanning the measurement light of the light emitting element 31 in the sample flow direction so that the illumination position of the measurement light passes through the band-like regions 41c and 41d after the elapse of the predetermined time in the present embodiment as well. Because the reflected light data of the band-like regions 41c and 41d that become the colored lines TL and CL and the peripheries thereof can thereby be acquired to enable preparation of an absorption profile such as shown in FIG. 14, the absorbance (coloration degree) can be measured reliably even if errors occur in the positions of the colored lines TL and CL.

The controller 14 of the present embodiment turns off the light emitting element 31 once after sensing the change of absorbance at the second position (band-like region 41d) and relights the light emitting element 31 thereafter to perform the operation of step S31 shown in FIG. 19 (the scanning of the measurement light of the light emitting element 31 in the sample flow direction to obtain the absorption profile of the measurement light in the detection portion 41b). Because the lighting time of the light emitting element 31 can thus be shortened, power consumption can be suppressed and the life of the light emitting element 31 can be extended.

### Modification Examples

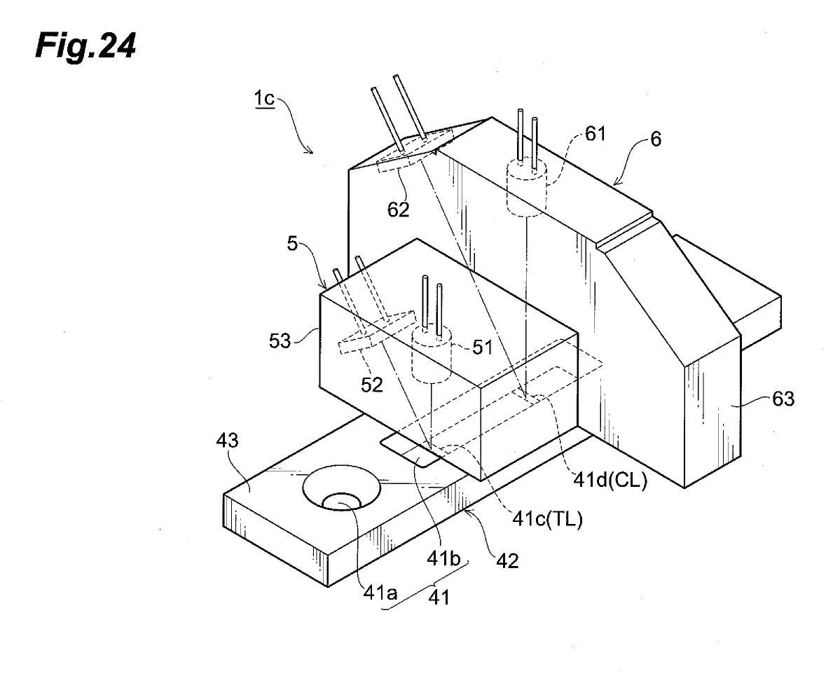

FIG. 24 is a perspective view of a configuration of a measuring apparatus 1c that is a modification example of the first embodiment. The measuring apparatus 1c includes a first optical head 5 and a second optical head 6. A light emitting element (first light illuminating unit) 51 and a photodetecting element (first photodetecting unit) 52 are integrally incorporated in the optical head 5. A light emitting element (second light illuminating unit) 61 and a photodetecting element (second photodetecting unit) 62 are integrally incorporated in the optical head 6.

The optical head 5 furthermore includes an unillustrated beam shaping member and lens for shaping measurement light emitted from the semiconductor light emitting element 51 to slit light substantially parallel to the band-like region 41c, and the semiconductor light emitting element 51, the semiconductor photodetecting element 52, the beam shaping member, and the lens are integrally held and defined in mutual positional relationship by a block-like member 53. The light emitting element 51 is held by the member 53 so that a light emitting direction thereof is perpendicular to the top surface of the immunochromatographic test strip 41 and illuminates the measurement light on the first position (band-like region 41c) of the immunochromatographic test strip 41. The photodetecting element 52 is disposed obliquely upward in a direction substantially parallel to the band-like region 41c from the first position (band-like region 41c) and converts reflected light from the first position (band-like region 41c) of the immunochromatographic test strip 41 to an electrical signal that is in accordance with the intensity of the reflected light.

The optical head 6 furthermore includes an unillustrated beam shaping member and lens for shaping measurement light emitted from the semiconductor light emitting element 61 to slit light substantially parallel to the band-like region 41d, and the semiconductor light emitting element 61, the semiconductor photodetecting element 62, the beam shaping member, and the lens are integrally held and defined in mutual positional relationship by a block-like member 63. The light emitting element 61 is held by the member 63 so that a light emitting direction thereof is perpendicular to the top surface of the immunochromatographic test strip 41 and illuminates the measurement light on the second position (band-like region 41d) of the immunochromatographic test strip 41. That is, an interval between an emission optical axis of the light emitting element 61 and an emission optical axis of the light emitting element 51 is set substantially equal to the interval between the first position (band-like region 41c) and the second position (band-like region 41d). The photodetecting element 62 is disposed obliquely upward in a direction substantially parallel to the band-like region 41d from the second position (band-like region 41d) and converts reflected light from the second position (band-like region 41d) of the immunochromatographic test strip 41 to an electrical signal that is in accordance with the intensity of the reflected light.

Each of the members 53 and 63 has two unillustrated holes of the same configuration as the holes 35a and 35b shown in FIG. 6 that make up baffle structures. One of the holes surrounds the optical path of the measurement light emitted from the light emitting element 51 (or 61), and the other hole surrounds an optical path of light reflected from the immunochromatographic test strip 41 and made incident on the photodetecting element 52 (or 62).

In the present modification example, unlike the first embodiment, the first optical head 5 is also configured with the baffle structures with the member 53 surrounding the optical path of the measurement light from the light emitting element 51 and the optical path of the reflected light from the first position (band-like region 41c). In the measuring apparatus according to the present invention, by surrounding the optical paths of the measurement light and the reflected light in at least one of the first and second optical heads, incidence of noise light on the photodetecting element of the corresponding optical head can be prevented to further improve the detection precision of reflected light.

Also, as in the present modification example, the interval between the emission optical axis of the first light illuminating unit and the emission optical axis of the second light illuminating unit in the present invention may be set in accordance with the interval between the first position and the second position of the immunochromatographic test strip.

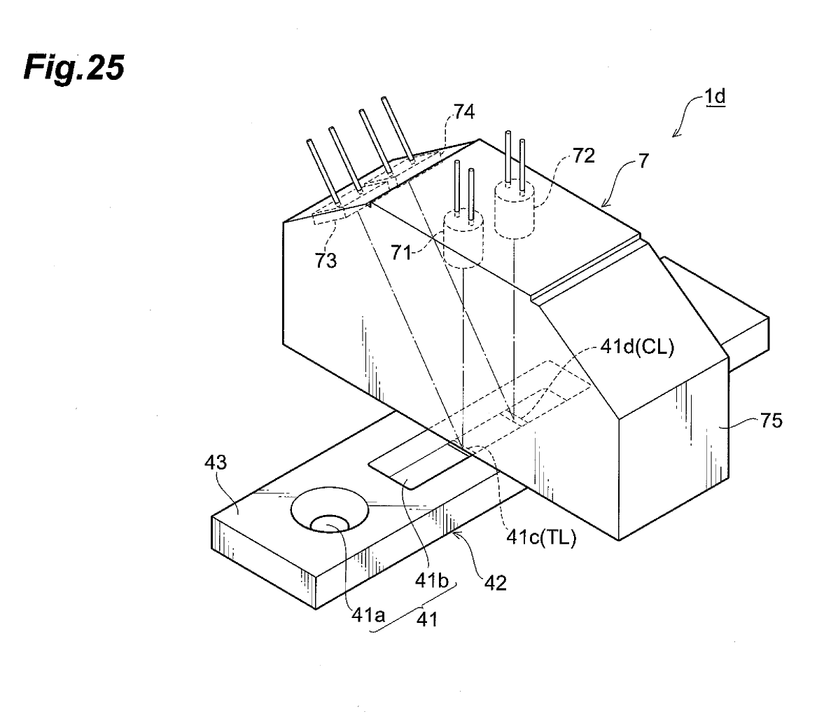

FIG. 25 is a perspective view of a configuration of a measuring apparatus 1d that is another modification example of the first embodiment. The measuring apparatus 1d includes an optical head 7 that is fixed in relative position with respect to the immunochromatographic test strip 41. Light emitting elements 71 and 72 and photodetecting elements 73 and 74 are integrally incorporated in the optical head 7 and thereby defined in mutual positional relationship. The light emitting element 71 is the first light illuminating unit in the present modification example, and the light emitting element 72 is the second light illuminating unit in the present modification example. The photodetecting element 73 is the first photodetecting unit in the present modification example, and the photodetecting element 74 is the second photodetecting unit in the present modification example.

The light emitting elements 71 and 72 are held by a member 75 so that light emitting directions thereof are perpendicular to the top surface of the immunochromatographic test strip 41. The light emitting element 71 illuminates measurement light on the first position (band-like region 41c) of the immunochromatographic test strip 41, and the light emitting element 72 illuminates measurement light on the second position (band-like region 41d). The photodetecting element 73 is disposed obliquely upward in a direction substantially parallel to the band-like region 41c from the first position (band-like region 41c) and converts reflected light from the first position (band-like region 41c) to an electrical signal that is in accordance with the intensity of the reflected light. The photodetecting element 74 is disposed obliquely upward in a direction substantially parallel to the band-like region 41d from the second position (band-like region 41d) of the immunochromatographic test strip 41 and converts reflected light from the second position (band-like region 41d) to an electrical signal that is in accordance with the intensity of the reflected light.

The member 75 has baffle structures of the same configuration as those of the member 35 shown in FIG. 6, and includes a hole surrounding the optical path of the measurement light emitted from the light emitting element 71, a hole surrounding the optical path of the measurement light emitted from the light emitting element 72, a hole surrounding an optical path of the light reflected from the first position (band-like region 41c) and made incident on the photodetecting element 73, and a hole surrounding an optical path of the light reflected from the second position (band-like region 41d) and made incident on the photodetecting element 74.

In the present modification example, because unlike the first embodiment, the first and second light illuminating units (the light emitting elements 71 and 72) and the first and second photodetecting units (the photodetecting elements 73 and 74) are integrally incorporated in a single optical head 7, the light emitting element 71 and the photodetecting element 73 as well as the light emitting element 72 and the photodetecting element 74 are positioned with good precision with respect to each other and the detection precision of reflected light can thus be improved. Also, because the optical head 7 has the member 75 that surrounds the optical paths of the measurement light and the reflected light, incidence of noise light on the photodetecting elements 73 and 74 can be prevented to improve the detection precision of reflected light.

### Third Embodiment

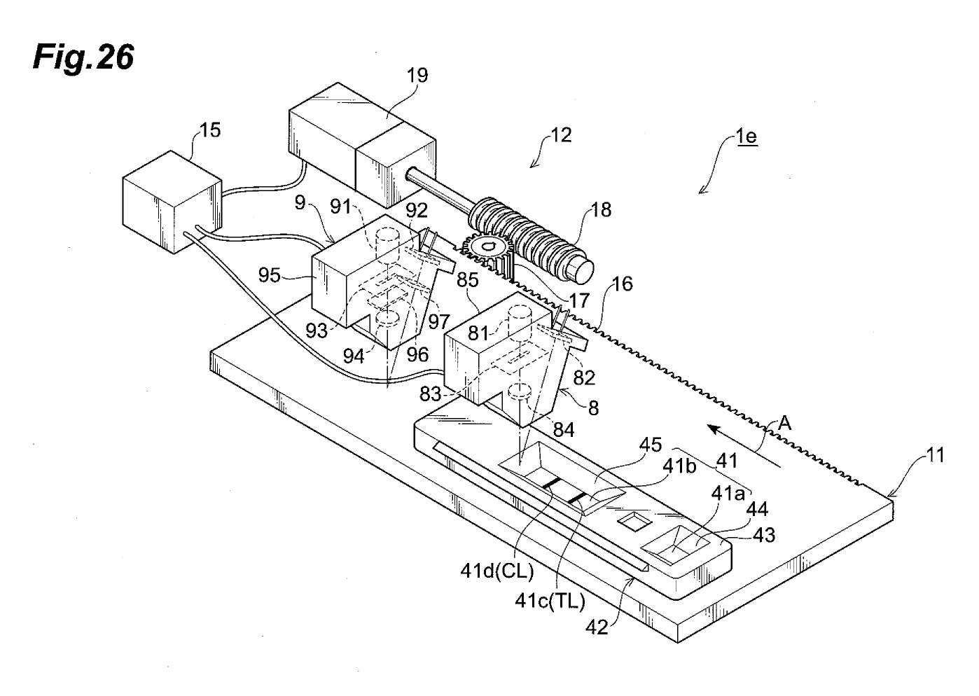

An immunochromatographic test strip measuring apparatus according to a third embodiment shall now be described. FIG. 26 is a perspective view of a configuration of the measuring apparatus 1e according to the present embodiment. The measuring apparatus 1e of the present embodiment illuminates measurement light (excitation light) on reaction lines (test line TL and control line CL) formed on the immunochromatographic test strip 41 containing a fluorescent substance and measures the reaction degrees of the reaction lines TL and CL by detecting intensities of fluorescence generated at the reaction lines TL and CL. As with the dye in the first embodiment, the fluorescent substance in the present embodiment labels an antibody (or antigen), coated on the immunochromatographic test strip 41 and binding with an antigen (or antibody) in the sample, and the reactions at the test line TL and the control line CL are the same as those in the first embodiment.

A main difference between the measuring apparatus 1e of the present embodiment and the first embodiment is a configuration of an optical head. That is, an optical head 8, which is a first optical head in the present embodiment, has the same configuration as the optical head 3 of the first embodiment. An optical head 9, which is a second optical head in the present embodiment, has a configuration for illuminating excitation light as measurement light on the reaction lines TL and CL formed in the immunochromatographic test strip 41 and detecting the intensity of the fluorescence generated at the reaction lines TL and CL. Configurations of the drive mechanism 12 and the immunochromatographic test utensil 42 in the present embodiment are the same as those of the first embodiment.

As shown in FIG. 26, the measuring apparatus 1e includes: the setting plate (test strip support) 11, for supporting the immunochromatographic test utensil 42 that has the immunochromatographic test strip 41; the first optical head 8, integrally incorporating a light emitting element (first light illuminating unit) 81, which illuminates the measurement light on the immunochromatographic test strip 41, and a photodetecting element (first photodetecting unit) 82, which detects the reflected light from the immunochromatographic test strip 41; the second optical head 9, integrally incorporating a light emitting element (second light illuminating unit) 91, which illuminates the measurement light (excitation light) on the immunochromatographic test strip 41, and a photodetecting element (second photodetecting unit) 92, which detects the fluorescence from the immunochromatographic test strip 41; the drive mechanism 12, moving the setting plate 11 in the sample flow direction relative to the optical heads 8 and 9; and a controller 15, controlling the optical heads 8 and 9 and the drive mechanism 12. Because the configurations of the setting plate 11, the drive mechanism 12, and the immunochromatographic test strip 41 are the same as in the first embodiment, detailed description thereof shall be omitted.

The optical head 8 has the same configuration as the optical head 3 of the first embodiment. That is, the optical head 8 has the light emitting element 81, the photodetecting element 82, a beam shaping member 83, and a lens 84, and these are held integrally and defined in mutual positional relationship by a member 85. A semiconductor light emitting element, such as a light emitting diode (LED), is used as the light emitting element 81, and a semiconductor photodetecting element, such as a silicon (Si) photodiode, is used as the photodetecting element 82. The light emitting element 81 is held by the member 85 so that an optical axis thereof is perpendicular to the top surface of the immunochromatographic test strip 41 and illuminates the measurement light on the immunochromatographic test strip 41. The photodetecting element 82 is disposed obliquely upward in a direction substantially parallel to the band-like regions 41c and 41d (see FIG. 2) from the illumination position of the measurement light on the immunochromatographic test strip 41 and converts the reflected light from the immunochromatographic test strip 41 to an electrical signal that is in accordance with the intensity of the reflected light.

The optical head 9 has substantially the same configuration as the optical head 8. That is, the optical head 9 has the light emitting element 91, the photodetecting element 92, a beam shaping member 93, and a lens 94, and these are held integrally and defined in mutual positional relationship by a member 95. However, a wavelength filter 96 is disposed between the beam shaping member 93 and the lens 94. The wavelength filter 96 takes out, from the light emitted from the light emitting element 91, a wavelength component necessary for excitation of the fluorescent substance. Also, a wavelength filter 97 is disposed between the photodetecting element 92 and the immunochromatographic test strip 41. The wavelength filter 97 makes just the fluorescence be incident on the photodetecting element 92 and cuts light of other wavelength ranges (light emitted from the light emitting element 91, etc.). The light emitting element 91 illuminates the immunochromatographic test strip 41 with the measurement light (excitation light) for exciting the fluorescent substance. The photodetecting element 92 converts the fluorescence from the immunochromatographic test strip 41 to an electrical signal that is in accordance with an intensity of the fluorescence.

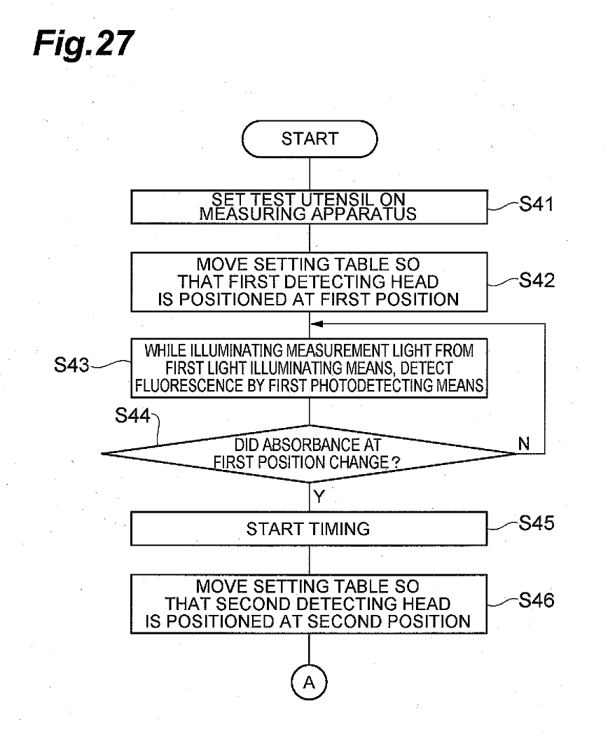

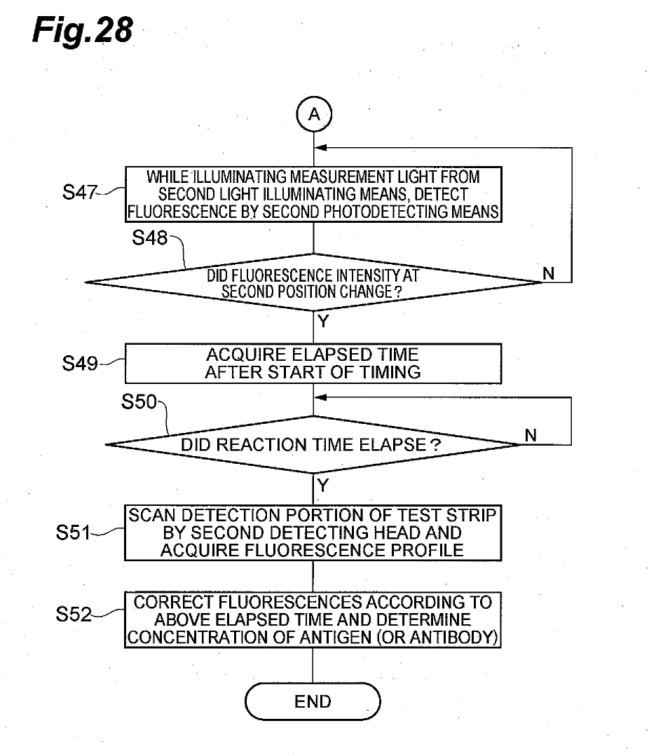

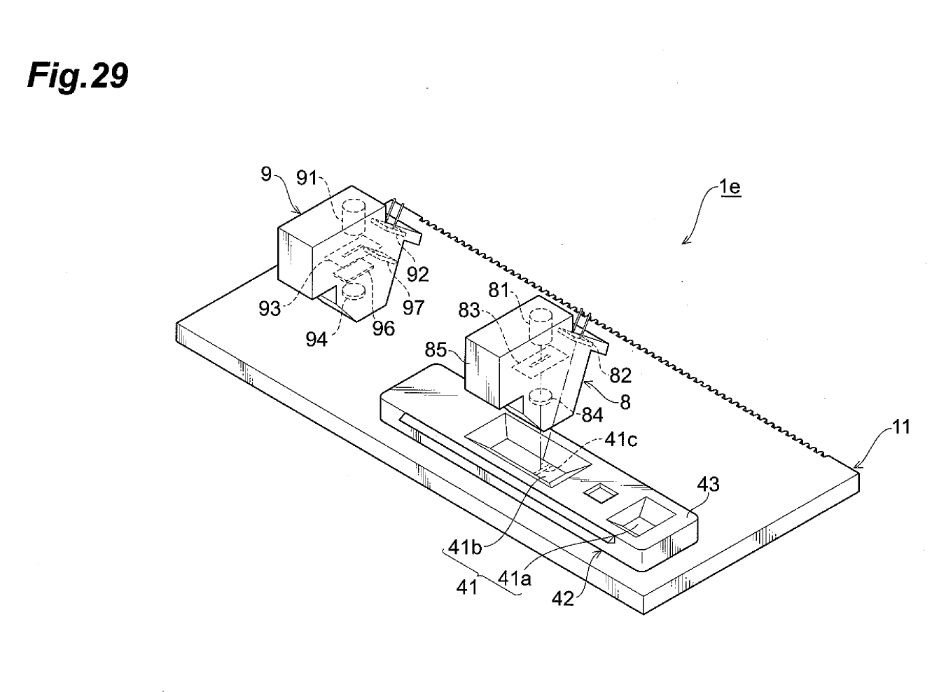

Operation of the measuring apparatus 1e according to the present embodiment shall now be described with reference to FIGS. 27 to 32. FIGS. 27 and 28 are flowcharts of the operation of the measuring apparatus 1e. FIGS. 29 to 32 are perspective views for describing operating states of the measuring apparatus 1e. In FIGS. 29 to 32, the drive mechanism 12 and the controller 15 shown in FIG. 26 are omitted from illustration.

First, a measurer sets the immunochromatographic test utensil 42 on the setting plate 11 (step S41). The controller 15 then moves the setting plate 11 and the optical head 8 in a relative manner so as to detect the reflected light from a first position of the immunochromatographic test strip 41 determined in advance. Specifically, the controller 15 moves the setting plate 11 by actuating the drive mechanism 12 and thereby controls the relative positional relationship of the optical head 8 and the immunochromatographic test strip 41 so that the first position on the immunochromatographic test strip 41 is positioned in a light emitting direction of the light emitting element 81 of the optical head 8 (step S42). In the present embodiment, the first position on the immunochromatographic test strip 41 is set inside the first band-like region 41c. Thus, as shown in FIG. 29, the band-like region 41c is positioned in the light emitting direction of the light emitting element 81.

Next, after the measurer drops a sample onto the sample application portion 41a, the light emitting element 81 illuminates the measurement light on the first position (that is, the band-like region 41c) of the immunochromatographic test strip 41. The photodetecting element 82 receives the reflected light and converts it to an electrical signal that is in accordance with the light intensity. The electrical signal is transmitted to the controller 15, and based on this electrical signal, the controller 15 senses the reflected light intensity at the first position (band-like region 41c) (step S43). The light emitting element 91 is unlit at this point.

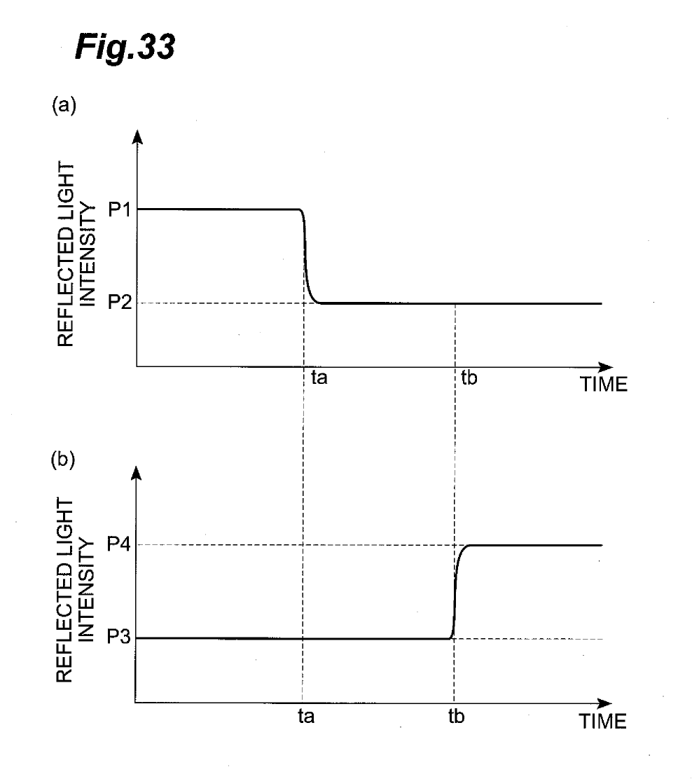

FIG. 33(a) is a schematic graph showing a manner of change of an optical characteristic (absorbance) at the first position (band-like region 41c). As described with the embodiment above, when the immunochromatographic test strip 41 is dry, reflected light of the comparatively high intensity P1 is detected by the photodetecting element 82. When the sample reaches the first position (band-like region 41c), because the absorbance increases, the intensity of the light reflected to the photodetecting element 82 changes to an intensity P2 (<P1). The controller 15 observes the change of absorbance based on the electrical signal from the photodetecting element 82 (step S44) and starts timing at the time to at which the absorbance changed (step S45). After sensing the change of absorbance at the first position (band-like region 41c), the controller 15 turns off the light emitting element 81.

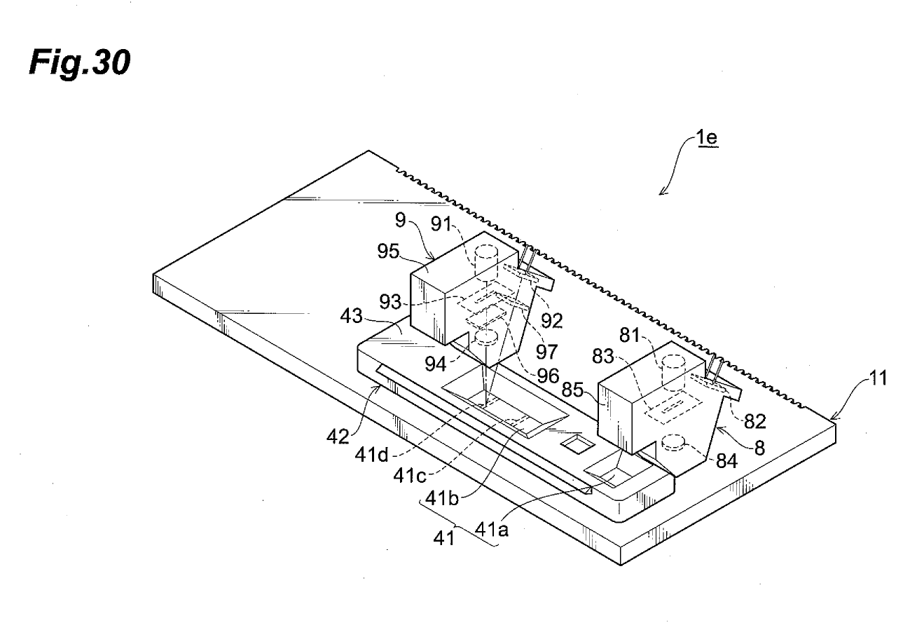

Subsequently, the controller 15 moves the setting plate 11 and the optical head 9 in a relative manner so as to detect the fluorescence from a second position on the immunochromatographic test strip 41 at a downstream side of the first position. Specifically, the controller 15 moves the setting plate 11 by actuating the drive mechanism 12 again and thereby controls the relative positional relationship of the optical head 9 and the immunochromatographic test strip 41 so that the second position on the immunochromatographic test strip 41 is positioned in a light emitting direction of the light emitting element 91 of the optical head 9 (step S46). In the present embodiment, the second position on the immunochromatographic test strip 41 is set inside the second band-like region 41d. Thus, as shown in FIG. 30, the band-like region 41d is positioned in the light emitting direction of the light emitting element 91. Thereafter, the controller 15 lights the light emitting element 91, and the light emitting element 91 illuminates the measurement light (excitation light) on the second position (that is, the band-like region 41d) of the immunochromatographic test strip 41. The photodetecting element 92 receives the fluorescence resulting from excitation by the measurement light and converts it to an electrical signal that is in accordance with the fluorescence intensity. The electrical signal is transmitted to the controller 15, and based on this electrical signal, the controller 15 senses the optical characteristic (fluorescence intensity) at the second position (band-like region 41d) (step S47).

FIG. 33(b) is a schematic graph showing a manner of change of an optical characteristic (fluorescence intensity) at the second position (band-like region 41d). In FIG. 15(b), the ordinate indicates the fluorescence intensity at the second position (band-like region 41d) and the abscissa indicates time. Until the sample reaches the second position (band-like region 41d), only light of an extremely low intensity P3 is detected by the photodetecting element 92 because a fluorescent substance is practically non-present at that position. When the sample reaches the second position (band-like region 41d), because the fluorescent substance labeling the antibody (or antigen) bound to the antigen (or antibody) in the sample is excited by the measurement light, the intensity of fluorescence directed to the photodetecting element 92 changes to an intensity P4 (>P3). The controller 15 observes the change of fluorescence intensity based on the electrical signal from the photodetecting element 92 (step S48) and acquires a difference between the time tb at which the fluorescence intensity changed and the time ta (tb−ta), that is, the elapsed time from the change of reflected intensity at the first position (band-like region 41c) to the change of fluorescence intensity at the second position (band-like region 41d) (step S49). After the fluorescence intensity has changed at the second position (band-like region 41d), the controller 15 turns off the light emitting element 91 once.

Then, using the time ta as a reference, the controller 15 performs counting of a predetermined time (step S50). During this predetermined time, the abovementioned first and second antigen-antibody reactions proceed and the reaction lines TL and CL become expressed at the band-like regions 41c and 41d. This predetermined time is set longer than the abovementioned elapsed time (tb−ta), for example, to approximately 15 minutes and adjusted as suited according to the type of the sample.

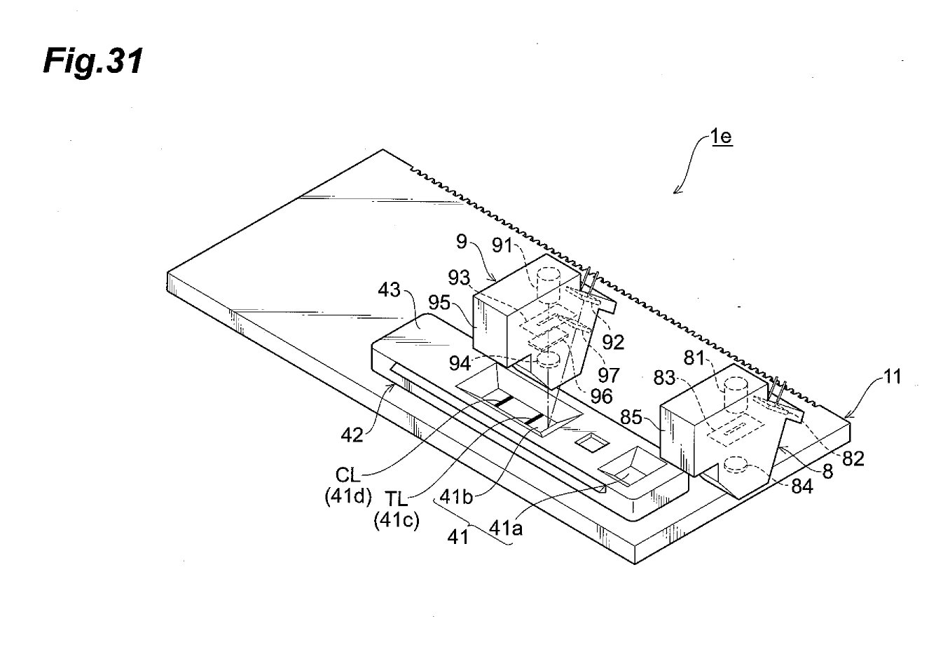

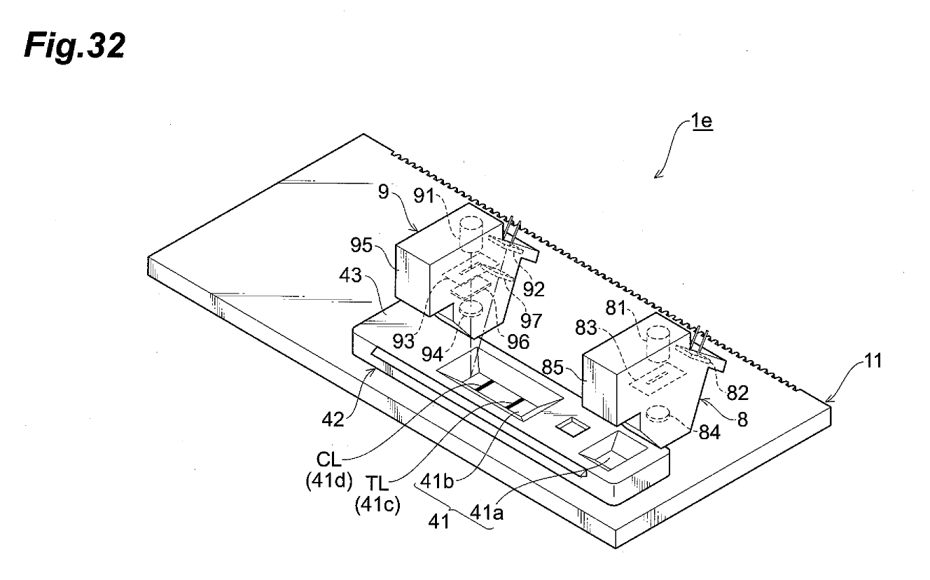

After the elapse of the predetermined time from the time ta, the controller 15 relights the light emitting element 91, and while scanning the measurement light of the light emitting element 91 in the sample flow direction so that the illumination position of the measurement light passes through the band-like regions 41c and 41d, detects the fluorescence by the photodetecting element 92 continuously (or intermittently), and obtains a fluorescence profile in the detection portion 41b (step S51). Specifically, the controller 15 actuates the drive mechanism 12 again to move the setting plate 11 and makes the end at the upstream side of the detection portion 41b be positioned in the light emitting direction of the light emitting element 91 as shown in FIG. 31. Then, while moving the illumination position of the measurement light toward the downstream side (that is, while moving the immunochromatographic test strip 41 to the upstream side relative to the optical head 9) until the end at the downstream side of the detection portion 41b is positioned in the light emitting direction of the light emitting element 91 (see FIG. 32), the controller 15 makes the light emitting element 91 illuminate the measurement light and acquires the electrical signal that is in accordance with the fluorescence intensity by the photodetecting element 92.

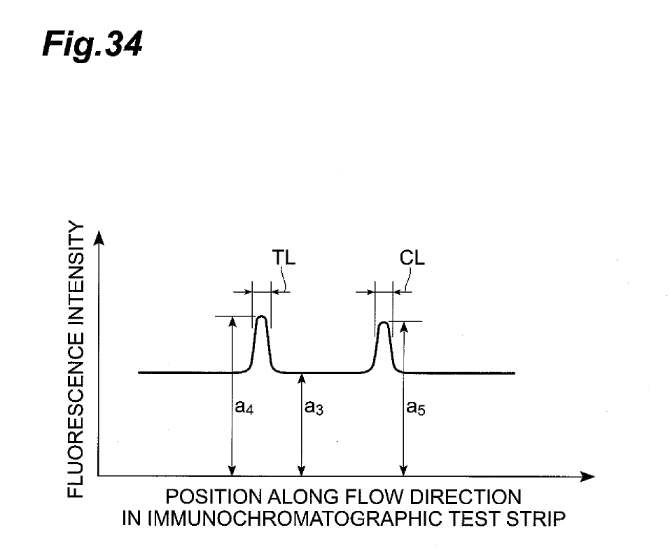

FIG. 34 is a diagram of an example of a fluorescence profile obtained by the above-described operation. In FIG. 34, the ordinate indicates the fluorescence intensity and the abscissa indicates the position on the detection portion 41b in the sample flow direction. The controller 15 prepares the fluorescence profile such as that shown in FIG. 34, and from the fluorescence profile, computes a fluorescence PL₁ of the test line TL and a fluorescence PL₂ of the control line CL on the immunochromatographic test strip 41 by the computation formulae: PL₁=log(a₄/a₃); and PL₂=log(a₅/a₃); respectively. The fluorescences PL₁ and PL₂ express the respective reaction degrees of the reaction lines TL and CL. Based on a relationship formula set in advance, the controller 15 corrects the fluorescences PL₁ and PL₂ according to the time (tb−ta). The controller 15 judges success or failure of measurement based on the corrected fluorescence PL₂ of the control line CL, and references a calibration curve diagram prepared in advance to determine a total amount (concentration) of the antigen (or antibody) contained in the sample in accordance with the corrected fluorescence PL₁ of the test line TL and outputs this by a display device, printer, or other output device (step S52).

The reaction degrees of the test line TL and the control line CL formed in the detection portion 41b of the immunochromatographic test strip 41 are thus measured by the measuring apparatus 1e of the present embodiment.

With the measuring apparatus 1e according to the present embodiment described above, by using the first photodetecting element 82, which detects the reflected light at the first position (band-like region 41c), and the second photodetecting element 92, which detects the fluorescence at the second position (band-like region 41d), to sense the change of absorbance or the change of fluorescence intensity at the respective positions, the timings to and tb at which the sample reaches the respective positions can be known. Because the controller 15 then acquires the elapsed time (tb−ta) from the change of absorbance at the first position (band-like region 41c) to the change of fluorescence intensity at the second position (band-like region 41d), the flow speed of the sample can be measured automatically. By the controller 15 (or the measurer) then correcting the fluorescences (reaction degrees) of the reaction lines TL and CL based on the elapsed time (tb−ta), the influence due to the fluctuation of reaction degree can be suppressed and the amount of the antigen (or antibody) in the sample can be analyzed with good precision.

The following modification is possible with the measuring apparatus 1e according to the present embodiment. That is, the same wavelength filters as the wavelength filters 96 and 97 of the optical head 9 may be disposed in the optical head 8 so that not reflected light but fluorescence is detected at the photodetecting element 82. Even with such a configuration, the timing ta at which the sample reaches the first position (band-like region 41c) can be made known favorably. That is, the fluorescent substance is developed along with the sample in the immunochromatographic test strip 41, and when a position reached by the sample is excited by the measurement light, fluorescence is generated and because the sample absorbs the measurement light at the same time, the absorbance decreases. The timings ta and tb can thus be made known by detecting one of either the reflected light or the fluorescence at the optical heads 8 and 9.

The following modification is furthermore possible with the measuring apparatus 1e according to the present embodiment. That is, as in the measuring apparatus 1b according to the second embodiment, acquisition of the timings ta and tb and measurement of the reaction degrees may be performed using a single optical head. In this case, the measuring apparatus has a configuration in which the optical head 8 of the present embodiment is excluded. That is, this measuring apparatus includes: the light emitting element (light illuminating unit) 91, illuminating the measurement light on the immunochromatographic test strip 41, on which a sample is dropped; the photodetecting element (photodetecting unit) 92, detecting the fluorescence from the immunochromatographic test strip 41 due to illumination of the measurement light; the setting plate (test strip support) 11, supporting the immunochromatographic test strip 41; the drive mechanism 12, moving the setting plate 11 and the photodetecting element 92 in a relative manner in the sample flow direction of the immunochromatographic test strip 41; and the controller 15, controlling the drive mechanism 12.

The controller 15 moves the setting plate 11 and the photodetecting element 92 in a relative manner to detect the fluorescence from the first position (band-like region 41c) on the immunochromatographic test strip 41, thereafter moves the setting plate 11 and the photodetecting element 92 in a relative manner to detect the fluorescence from the second position (band-like region 41d), and, based on the output signals from the photodetecting element 92, acquires the elapsed time from the change of fluorescence intensity at the first position (band-like region 41c) to the change of fluorescence intensity at the second position (band-like region 41d). By this configuration, because the changes of fluorescence intensity at the respective positions can be sensed favorably, the timings to and tb at which the sample reaches the respective positions can be made known.

The present invention is not restricted to the respective embodiments and modification examples described above. For example, as the light illuminating unit, a laser diode or other semiconductor light emitting element may be used in place of the light emitting diode. Also, as the photodetecting unit, in place of the Si photodiode, a phototransistor or other semiconductor light receiving element, or a photoelectric tube, a photomultiplier tube, or other vacuum tube type photosensor may be used.

Also, with the respective embodiments described above, the first position in the immunochromatographic test strip 41 is set in the band-like region 41c that is to be the test line TL and the second position is set in the band-like region 41d that is to be the control line CL. The first and second positions in the present invention are not restricted to these and may be set to any positions on the immunochromatographic test strip.

Also, although with the embodiments described above, in regard to the correlation of the coloration degree and the flow speed of the sample, the correlation shown in FIG. 16 such that the longer the time (tb−ta), the higher the absorbance ABS₁ was described as an example, the correlation between the two is not restricted thereto. For example, even with a correlation such that the absorbance ABSᵢ becomes lower the longer the time (tb−ta), by correcting the reaction degrees at the lines TL and CL based on the time (tb−ta), the influence of the fluctuation of reaction degree can be suppressed and the amount of an antigen (or antibody) in a sample can be analyzed with good precision with the measuring method according to the present invention.

Also, although with the respective embodiments described above, the drive mechanism moves the sample strip support (setting plate 11) to move the immunochromatographic test strip and the light illuminating unit in a relative manner, the sample strip support may be fixed and the drive mechanism may move the light illuminating unit to move the immunochromatographic test strip and the light illuminating unit in a relative manner. Or, the drive mechanism may move both the test strip support and the light illuminating unit to move the immunochromatographic test strip and the light illuminating unit in a relative manner.

1. An immunochromatographic test strip measuring apparatus comprising:
one or a plurality of light illuminating units, illuminating measurement light on an immunochromatographic test strip;
a first photodetecting unit, detecting light obtained from the immunochromatographic test strip by illumination of the measurement light on a first position on the immunochromatographic test strip;
a second photodetecting unit, detecting light obtained from the immunochromatographic test strip by illumination of the measurement light on a second position at a downstream side of the first position on the immunochromatographic test strip; and
a controller, acquiring, based on output signals from the first and second photodetecting units, an elapsed time from a change of optical characteristic at the first position to a change of optical characteristic at the second position.

2. An immunochromatographic test strip measuring apparatus comprising:
a light illuminating unit, illuminating measurement light on an immunochromatographic test strip;
a photodetecting unit, detecting light obtained from the immunochromatographic test strip by illumination of the measurement light;
a test strip support, supporting the immunochromatographic test strip;
a drive mechanism, moving the test strip support and the photodetecting unit in a relative manner in a sample flow direction of the immunochromatographic test strip; and
a controller, controlling the drive mechanism; and
wherein the controller makes the test strip support and the photodetecting unit move in a relative manner to detect light from a first position on the immunochromatographic test strip, then makes the test strip support and the photodetecting unit move in a relative manner to detect light from a second position at a downstream side of the first position, and acquires, based on output signals from the photodetecting unit, an elapsed time from a change of optical characteristic at the first position to a change of optical characteristic at the second position.

3. An immunochromatographic test strip measuring apparatus comprising:
one or a plurality of light illuminating units, illuminating measurement light on an immunochromatographic test strip;
a first photodetecting unit, detecting reflected light from the immunochromatographic test strip due to illumination of the measurement light on a first position on the immunochromatographic test strip;
a second photodetecting unit, detecting reflected light from the immunochromatographic test strip due to illumination of the measurement light on a second position at a downstream side of the first position on the immunochromatographic test strip; and
a controller, acquiring, based on output signals from the first and second photodetecting units, an elapsed time from a change of absorbance at the first position to a change of absorbance at the second position.

4. The immunochromatographic test strip measuring apparatus according to claim 3, comprising:
first and second light illuminating units; and
wherein the first photodetecting unit detects the reflected light due to illumination by the first light illuminating unit, and
the second photodetecting unit detects the reflected light due to illumination by the second light illuminating unit.

5. The immunochromatographic test strip measuring apparatus according to claim 4, comprising:
a first optical head, integrally incorporating the first light illuminating unit and the first photodetecting unit; and
a second optical head, integrally incorporating the second light illuminating unit and the second photodetecting unit; and
wherein at least one of the first and second optical heads has a member surrounding optical paths of the measurement light and the reflected light.

6. The immunochromatographic test strip measuring apparatus according to claim 5, wherein an interval between the first optical head and the second optical head is variable.

7. The immunochromatographic test strip measuring apparatus according to claim 4, further comprising: an optical head, integrally incorporating the first and second light illuminating units and the first and second photodetecting units; and
wherein the optical head has a member surrounding optical paths of the measurement light and the reflected light.

8. The immunochromatographic test strip measuring apparatus according to claim 4, wherein the second light illuminating unit is lit after the first light illuminating unit is turned off.

9. The immunochromatographic test strip measuring apparatus according to claim 3, wherein
the immunochromatographic test strip has a band-like region causing an antigen-antibody reaction with a sample, and
the controller acquires absorbance at the band-like region after elapse of a predetermined time, longer than the elapsed time, from the change of absorbance at the first position.

10. The immunochromatographic test strip measuring apparatus according to claim 9, further comprising: a test strip support, supporting the immunochromatographic test strip; and
a drive mechanism, controlled by the controller and moving either or both of the first and second light illuminating units and the test strip support in a relative manner in a sample flow direction of the immunochromatographic test strip; and
wherein, after elapse of the predetermined time, the controller scans the measurement light of the first or the second light illuminating unit in the sample flow direction so that an illumination position of the measurement light passes through the band-like region.

11. The immunochromatographic test strip measuring apparatus according to claim 10, wherein the controller turns off the second light illuminating unit after the change of absorbance at the second position and thereafter relights the second light illuminating unit to perform scanning after the elapse of the predetermined time.

12. An immunochromatographic test strip measuring apparatus comprising:
a light illuminating unit, illuminating measurement light on an immunochromatographic test strip;
a photodetecting unit, detecting reflected light from the immunochromatographic test strip due to illumination of the measurement light;
a test strip support, supporting the immunochromatographic test strip;
a drive mechanism, moving the test strip support and the photodetecting unit in a relative manner in a sample flow direction of the immunochromatographic test strip; and
a controller, controlling the drive mechanism; and
wherein the controller makes the test strip support and the photodetecting unit move in a relative manner to detect the reflected light from a first position on the immunochromatographic test strip, then makes the test strip support and the photodetecting unit move in a relative manner to detect the reflected light from a second position at a downstream side of the first position, and acquires, based on output signals from the photodetecting unit, an elapsed time from a change of absorbance at the first position to a change of absorbance at the second position.

13. The immunochromatographic test strip measuring apparatus according to claim 12, further comprising: an optical head, integrally incorporating the light illuminating unit and the photodetecting unit; and
wherein the drive mechanism moves the test strip support and the optical head in a relative manner.

14. The immunochromatographic test strip measuring apparatus according to claim 12, wherein
the immunochromatographic test strip has a band-like region causing an antigen-antibody reaction with a sample, and
the controller acquires absorbance at the band-like region after elapse of a predetermined time, longer than the elapsed time, from the change of absorbance at the first position.

15. The immunochromatographic test strip measuring apparatus according to claim 14, wherein, after elapse of the predetermined time, the controller scans the measurement light of the light illuminating unit in the sample flow direction so that an illumination position of the measurement light passes through the band-like region.

16. The immunochromatographic test strip measuring apparatus according to claim 15, wherein the controller turns off the light illuminating unit after the change of absorbance at the second position and thereafter relights the light illuminating unit to perform scanning after the elapse of the predetermined time.

17. The immunochromatographic test strip measuring apparatus according to claim 3, wherein
the immunochromatographic test strip has a first band-like region, causing a first antigen-antibody reaction, and a second band-like region, disposed at a downstream side of the first band-like region and causing a second antigen-antibody reaction,
the first position is disposed inside the first band-like region, and the second position is disposed inside the second band-like region.

18. An immunochromatographic test strip measuring apparatus comprising:
one or a plurality of light illuminating units, illuminating measurement light on an immunochromatographic test strip;
a first photodetecting unit, detecting reflected light or fluorescence from the immunochromatographic test strip due to illumination of the measurement light on a first position on the immunochromatographic test strip;
a second photodetecting unit, detecting reflected light or fluorescence from the immunochromatographic test strip due to illumination of the measurement light on a second position at a downstream side of the first position on the immunochromatographic test strip; and
a controller, acquiring, based on output signals from the first and second photodetecting units, an elapsed time from a change of absorbance or fluorescence intensity at the first position to a change of absorbance or fluorescence intensity at the second position.

19. An immunochromatographic test strip measuring apparatus comprising:
a light illuminating unit, illuminating measurement light on an immunochromatographic test strip;
a photodetecting unit, detecting fluorescence from the immunochromatographic test strip due to illumination of the measurement light;
a test strip support, supporting the immunochromatographic test strip;
a drive mechanism, moving the test strip support and the photodetecting unit in a relative manner in a sample flow direction of the immunochromatographic test strip; and
a controller, controlling the drive mechanism; and
wherein the controller makes the test strip support and the photodetecting unit move in a relative manner to detect the fluorescence from a first position on the immunochromatographic test strip, then makes the test strip support and the photodetecting unit move in a relative manner to detect the fluorescence from a second position at a downstream side of the first position, and acquires, based on output signals from the photodetecting unit, an elapsed time from a change of fluorescence intensity at the first position to a change of fluorescence intensity at the second position.
